(19) United States
(12) Patent Application Publication
(10) Pub. No.: US 2026/0242079 A1
(43) Pub. Date: Aug. 20, 2026

(54) INDUSTRIAL AERIAL ROBOT SYSTEMS AND METHODS

(71) Applicant: Thomas W. Melcher, Mesa, AZ (US)

(72) Inventor: Thomas W. Melcher, Mesa, AZ (US)

(21) Appl. No.: 18/999,796

(22) Filed: Dec. 23, 2024

Related U.S. Application Data
(63) Continuation of application No. PCT/US2023/026157, filed on Jun. 23, 2023.
(63) Continuation of application No. PCT/US2023/026101, filed on Jun. 23, 2023.
(63) Continuation of application No. PCT/US2023/026161, filed on Jun. 23, 2023.
(60) Provisional application No. 63/355,972, filed on Jun. 27, 2022.
(60) Provisional application No. 63/355,972, filed on Jun. 27, 2022.
(60) Provisional application No. 63/355,972, filed on Jun. 27, 2022.
(60) Provisional application No. 63/481,105, filed on Jan. 23, 2023.
(60) Provisional application No. 63/481,105, filed on Jan. 23, 2023.
(60) Provisional application No. 63/481,105, filed on Jan. 23, 2023.

(51) Int. Cl. B64U 30/26; B64U 10/20; B64U 20/94; B64U 30/10; B64U 50/19

(52) U.S. Cl. CPC B64U 30/26; B64U 10/20; B64U 20/94; B64U 30/10; B64U 50/19

(57) ABSTRACT

A propulsion system includes a first plurality of rotor blades configured to rotate about an engine longitudinal axis and a motor module. The motor module includes a plurality of electric motors for rotating the first plurality of rotor blades. The propulsion system can further include a dual power turbine including a first power turbine module and a second power turbine module.

### CROSS REFERENCE TO RELATED APPLICATIONS

This application is a Continuation of International Application No. PCT/US2023/026157, entitled “INDUSTRIAL AERIAL ROBOT SYSTEMS AND METHODS,” filed on Jun. 23, 2023, which claims priority to, and the benefit of, U.S. Provisional Patent Application Ser. No. 63/355,972, entitled “INDUSTRIAL AERIAL ROBOT,” filed on Jun. 27, 2022, and further claims priority to, and the benefit of, U.S. Provisional Patent Application Ser. No. 63/481,105, entitled “INDUSTRIAL AERIAL ROBOT SYSTEMS AND METHODS,” filed on Jan. 23, 2023. This application is a Continuation of International Application No. PCT/US2023/026101, entitled “INDUSTRIAL AERIAL ROBOT SYSTEMS AND METHODS,” filed on Jun. 23, 2023, which claims priority to, and the benefit of, U.S. Provisional Patent Application Ser. No. 63/355,972, entitled “INDUSTRIAL AERIAL ROBOT,” filed on Jun. 27, 2022, and further claims priority to, and the benefit of, U.S. Provisional Patent Application Ser. No. 63/481,105, entitled “INDUSTRIAL AERIAL ROBOT SYSTEMS AND METHODS,” filed on Jan. 23, 2023. This application is a Continuation of International Application No. PCT/US2023/026161, entitled “INDUSTRIAL AERIAL ROBOT SYSTEMS AND METHODS,” filed on Jun. 23, 2023, which claims priority to, and the benefit of, U.S. Provisional Patent Application Ser. No. 63/355,972, entitled “INDUSTRIAL AERIAL ROBOT,” filed on Jun. 27, 2022, and further claims priority to, and the benefit of, U.S. Provisional Patent Application Ser. No. 63/481,105, entitled “INDUSTRIAL AERIAL ROBOT SYSTEMS AND METHODS,” filed on Jan. 23, 2023. The ‘157, ‘101, ‘161, ‘972, and ‘105 Applications are hereby incorporated by reference in their entirety for all purposes, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

The present disclosure relates in general to transportation systems, and, more particularly, to a transportation system using an electric vertical takeoff and landing (eVTOL) and short takeoff and landing (STOL) aircraft to transport heavy payloads.

### BACKGROUND

Aircraft carry different payloads, including for example, passengers, cargo, sensors, and munitions. Various requirements can shape an aircraft design; for example, some missions require flight in a certain speed regime, some missions require heavy payload-carrying capacity, while other missions require high fuel efficiency.

One type of popular conventional aircraft is a helicopter which employs a single main rotor to provide both lift and thrust and an anti-torque tail rotor to prevent the body of the aircraft rotating in a contrary sense to the main rotor to provide directional control. Moreover, numerous multi-rotor systems have also been proposed over the years where different rotors can rotate in opposite senses to cancel out induced torque values. Multi-rotor aircraft are used and/or proposed for use in a range of applications including cargo and/or passenger transport. Multi-rotor aircraft benefit in particular from a reduced or eliminated need to generate horizontal velocity before takeoff. Some multi-rotor aircraft utilize one thrust generating system for vertical takeoff and/or landing capability, while using a separate thrust generating system in forward flight. Utilizing separate systems for vertical takeoff and landing and forward flight tends to result in reduced efficiency—e.g., reduced power-to-mass ratio, and increased disc loading—of the aircraft, thereby also reducing the overall payload capacity.

Therefore, a need exists for a transportation system with increased efficiency—i.e., power-to-mass ratio and reduced disc loading—capable of handling heavy cargo payload requirements while also being economically feasible.

### SUMMARY

In accordance with various embodiments, an aircraft is disclosed comprising a boom, a propulsion system coupled to a first end of the boom via a stanchion, and a first wing coupled to a second end of the boom. The propulsion system comprises a first plurality of rotor blades configured to rotate about an engine longitudinal axis, and a motor module comprising a first plurality of electric motors for rotating the first plurality of rotor blades.

In various embodiments, the propulsion system further comprises a second plurality of rotor blades disposed opposite the motor module from the first plurality of rotor blades, and a first plurality of stator vanes extending from the motor module, wherein the first plurality of stator vanes is located axially between the first plurality of rotor blades and the second plurality of rotor blades. In various embodiments, the propulsion system further comprises a duct coupled to the first plurality of stator vanes and defining a core flow path.

In various embodiments, the propulsion system further comprises a second plurality of stator vanes and a duct coupled to the first plurality of stator vanes and defining a core flow path. The duct can include a first half slidingly coupled to a second half, the first half is coupled to the first plurality of stator vanes and the second half is coupled to the second plurality of stator vanes, and the first half is configured to rotate about the propulsion system longitudinal axis with respect to the second half.

In various embodiments, the propulsion system further comprises a duct coupled to the first plurality of stator vanes and defining a core flow path, an annular groove disposed in the duct, a floating air bearing disposed in the annular groove, and a plurality of inlets disposed circumferentially about the duct and in fluid communication with the annular groove, wherein the plurality of inlets are configured to divert a portion of a core air flow and direct the portion of the core air flow to the annular groove.

In various embodiments, the first plurality of electric motors comprises a first electric motor and a second electric motor. The motor module can further comprise a plurality of heat exchangers comprising a first heat exchanger and a second heat exchanger, a first coolant reservoir, a second coolant reservoir, and a first coolant flow path extending from the first coolant reservoir, through the first electric motor, through the second coolant reservoir, through the first heat exchanger, and back into the first coolant reservoir. In various embodiments, the first heat exchanger comprises an aerodynamic surface configured to be in fluid communication with a core air flow during operation of the propulsion system.

In various embodiments, the motor module further comprises a center frame at least partially defining a first motor cavity, a second motor cavity, and a third motor cavity. In various embodiments, the first electric motor is disposed in the first motor cavity, the second electric motor is disposed in the second motor cavity, and the first plurality of electric motors further comprises a third electric motor disposed in the third motor cavity.

In various embodiments, the first coolant reservoir comprises a first coolant cavity fluidly sealed from a second coolant cavity and a third coolant cavity. In various embodiments, the first coolant cavity is in fluid communication with the first electric motor via the first coolant flow path, the second coolant cavity is in fluid communication with the second electric motor via a second coolant flow path, and the third coolant cavity is in fluid communication with the third electric motor via a third coolant flow path. In various embodiments, the motor module further comprises a first motor control housing for the first electric motor, a second motor control housing for the second electric motor, and a third motor control housing for the third electric motor. The first coolant flow path can be in fluid communication with the first motor control housing.

In various embodiments, the motor module further comprises a center frame comprising a first flange, a harmonic damper comprising a second flange, and a damper ring disposed between the first flange and the second flange. In various embodiments, the harmonic damper further comprises a first post extending into an output shaft of a first electric motor of the first plurality of electric motors, wherein a bearing is disposed between the first post and the output shaft of the first electric motor, wherein the bearing is configured to transfer loads between the first post and the output shaft of the first electric motor.

In various embodiments, the first plurality of electric motors comprises a first electric motor, a second electric motor, and a third electric motor. The motor module may further comprise a first output shaft meshingly engaged with the first electric motor, the second electric motor, and the third electric motor. The first plurality of electric motors may be configured to drive the first output shaft. The first plurality of rotor blades may be mounted to the first output shaft. The aircraft can further comprise a second plurality of electric motors comprising a fourth electric motor, a fifth electric motor, and a sixth electric motor. The motor module can further comprise a second output shaft meshingly engaged with the fourth electric motor, the fifth electric motor, and the sixth electric motor. The second plurality of electric motors can be configured to drive the second output shaft, and the second plurality of rotor blades can be mounted to the second output shaft.

In accordance with various embodiments, a propulsion system is disclosed comprising a first plurality of rotor blades configured to rotate about an engine longitudinal axis, and a motor module. The motor module comprises a first plurality of electric motors for rotating the first plurality of rotor blades, and a harmonic damper comprising a plurality of posts, wherein each post extends into an output shaft of the first plurality of electric motors.

In various embodiments, the propulsion system further comprises a second plurality of rotor blades disposed opposite the motor module from the first plurality of rotor blades, and a first plurality of stator vanes extending from the motor module, wherein the first plurality of stator vanes is located axially between the first plurality of rotor blades and the second plurality of rotor blades.

In various embodiments, the motor module further comprises a center frame comprising a first flange, and a damper ring disposed between the first flange and a second flange of the harmonic damper. The damper ring can comprise an elastomeric material.

In various embodiments, the first plurality of electric motors is mounted to the center frame. In various embodiments, the center frame comprises an end plate, and each output shaft of the first plurality of electric motors extends through the end plate.

In accordance with various embodiments, a propulsion system is disclosed comprising a first plurality of rotor blades configured to rotate about an engine longitudinal axis, and a motor module comprising a first plurality of electric motors for rotating the first plurality of rotor blades, a first coolant reservoir configured to contain a coolant for providing cooling to the first plurality of electric motors, and a plurality of heat exchangers disposed circumferentially about the motor module and at least partially defining a core flow path through the propulsion system.

In various embodiments, the propulsion system further comprises a ram air inlet extending through a first heat exchanger of the plurality of heat exchangers into the core flow path, and a ram air exhaust in fluid communication with the core air flow path, wherein the ram air inlet is configured to receive a cooling air from the core flow path and direct the cooling air through at least a first electric motor of the first plurality of electric motors, and the ram air exhaust is configured to direct the cooling air from at least the first electric motor back into the core flow path.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the figures, wherein like numerals denote like elements.

FIG. 1A through FIG. 1D are perspective views of a skyboom electric vertical takeoff and landing (eVTOL) aircraft during various phases of flight, in accordance with various embodiments;

FIG. 2A is a side view of a propulsion system for the eVTOL aircraft, in accordance with various embodiments;

FIG. 2B is a perspective view of a propulsion system for the eVTOL aircraft including a floating air bearing for a duct and a nose cone, in accordance with various embodiments;

FIG. 2C and FIG. 2D are an enlarged views of the motor module installed in the propulsion system of FIG. 2A with a motor module cover removed and installed, respectively, in accordance with various embodiments;

FIG. 3A and FIG. 3B are schematic views of a motor module for the rotor blades of the propulsion system for an eVTOL aircraft without and with the rotor blades installed, respectively, in accordance with various embodiments;

FIG. 4A is an assembly view of a motor module, in accordance with various embodiments;

FIG. 4B is a partial assembly view of the motor module of FIG. 4A, in accordance with various embodiments;

FIG. 5 is a section view of a harmonic damper installed with an output shaft of an electric motor, in accordance with various embodiments;

FIG. 6 is a perspective view of a partially assembled motor module, in accordance with various embodiments;

FIG. 7 is a perspective view of inboard ends of stator vanes coupled to a motor housing (also referred to herein as a center frame) of a motor module, in accordance with various embodiments;

FIG. 8 is a schematic view of coolant flow paths through a motor module, in accordance with various embodiments;

FIG. 9A and FIG. 9B are perspective views of a turbine module for a propulsion system of the eVTOL aircraft, in accordance with various embodiments;

FIG. 10 is a perspective view of a propulsion system for the eVTOL aircraft including a two piece duct, in accordance with various embodiments;

FIG. 11A is a bottom or aft view of a propulsion system for the eVTOL aircraft including a floating air bearing, in accordance with various embodiments;

FIG. 11B is a section view of the floating air bearing of FIG. 11A, in accordance with various embodiments;

FIG. 12A is a perspective view of a dual power turbine, in accordance with various embodiments;

FIG. 12B is an enlarged view of the dual power turbine of FIG. 12A with a ring gear sleeve removed, in accordance with various embodiments;

FIG. 12C is a schematic view of the planetary gear drive of the dual power turbine of FIG. 12B, in accordance with various embodiments;

FIG. 12D is a schematic view of the planetary gear drive of FIG. 12C, in accordance with various embodiments;

FIG. 13 is a perspective views of a blade actuation control system for a power turbine module, in accordance with various embodiments;

FIG. 14A and FIG. 14B are perspective views of an eVTOL aircraft during a payload loading maneuver, in accordance with various embodiments; and

FIG. 15A is a schematic view of a propulsion system for the eVTOL aircraft including the rotor blades and stator vanes, in accordance with various embodiments; and

FIG. 15B through FIG. 15E are schematic views of the rotor blades and stator vanes of the propulsion system with the rotor blades rotated at various pitch angles during a shuttering maneuver, in accordance with various embodiments.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the appended statements.

For the sake of brevity, conventional techniques for electric motor construction, configuration, and use, as well as conventional techniques for rotor blade, stator blade, and nacelle management, operation, optimization, and/or control, may not be described in detail herein. Furthermore, the connecting lines shown in various figures contained herein are intended to represent exemplary functional relationships and/or physical couplings between various elements. It should be noted that many alternative or additional functional relationships or physical connections may be present in a practical system or related methods of use.

Various shortcomings of prior rotary wing aircraft, fixed wing aircraft, and/or the like can be addressed by utilizing industrial aerial robots and related components configured in accordance with principles of the present disclosure. For example, prior propulsion approaches may typically utilize an engine coupled to rotor blades via a drivetrain for maintaining flight of the aircraft. The drivetrain may typically expose single points of failure for the aircraft. Moreover, the remainder of the aircraft (e.g., the fuselage, the cockpit, the tail boom, etc.) typically may comprise additional mass which does not directly contribute to powering, or generating thrust and/or lift to, the aircraft. In contrast, exemplary systems and methods disclosed herein utilize the entire, or nearly the entire, mass of the aircraft to maintain angular spin momentum, resulting in increased power/mass ratio.

An electric propulsion system for an eVTOL aircraft of the present disclosure can include power turbine modules located in a lower half of a shroud to convert propulsive thrust into mechanical torque. Rotating the entire aircraft tends to reduce or eliminate the need for complex combiner/reduction transmissions. A long torsion tube, i.e., fuselage/boom, provides differential compliance between the two rotors. Two large triaxial joints at either end of the boom tend to eliminate the need for conventional flight control apparatus within the wings, thus allowing the wings to also serve as rotors. In an example embodiment, on-demand service of an eVTOL aircraft of the present disclosure does not require landing gear. In an example embodiment, on-demand service of an eVTOL aircraft of the present disclosure does not require the eVTOL aircraft to return to a storage system (e.g., a silo) before continuing or starting a new mission.

The vast majority (e.g., 91%) of the aircraft's mass can be located near the axis of rotation (e.g., within 18.00 inches (45.72 cm) of the axis of rotation) of an eVTOL aircraft of the present disclosure. The remaining mass (e.g., the remaining 9%) can consist of rotorwings, stator-vanes, propulsion and power turbine blades. The inherent gyroscopic stability of the design tends to allow independent out of phase pitch moments to be introduced into the cyclic (i.e., pitch angle control or feathering angle control of each main rotor blade—also referred to herein as a wing or a rotorwing) for better control of the co-rotating design.

The electric propulsion system for an eVTOL aircraft of the present disclosure can include independently actuated power-turbine/diverter blades for improved positioning, in accordance with various embodiments. The electric propulsion system of the present disclosure can seamlessly mirror load change allowing high frequency shuttering of the turbine blades without loss of inertia. Precise altitude control can be achieved by rapidly shuttering the turbine blades to create pulse thrust moments. In an example embodiment, precise altitude control using systems and methods of the present disclosure reduce payload coupling duration.

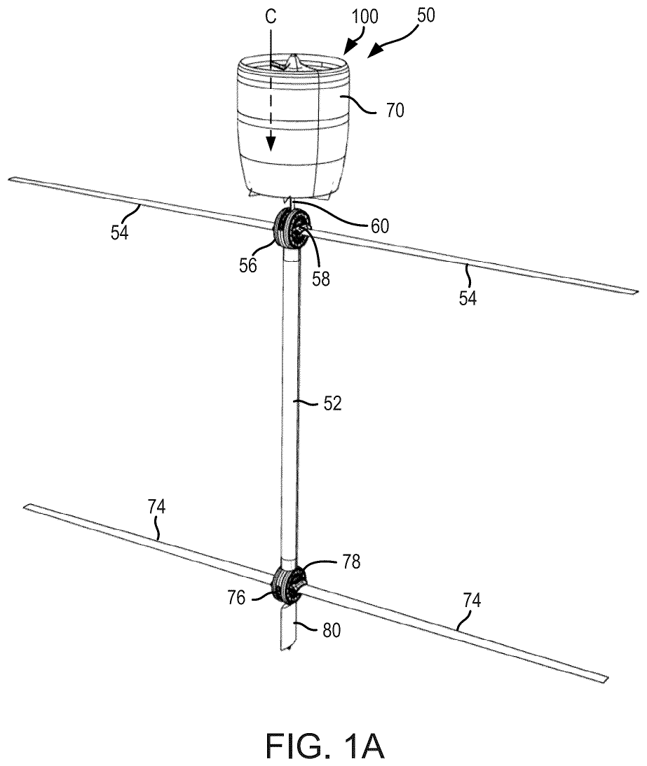

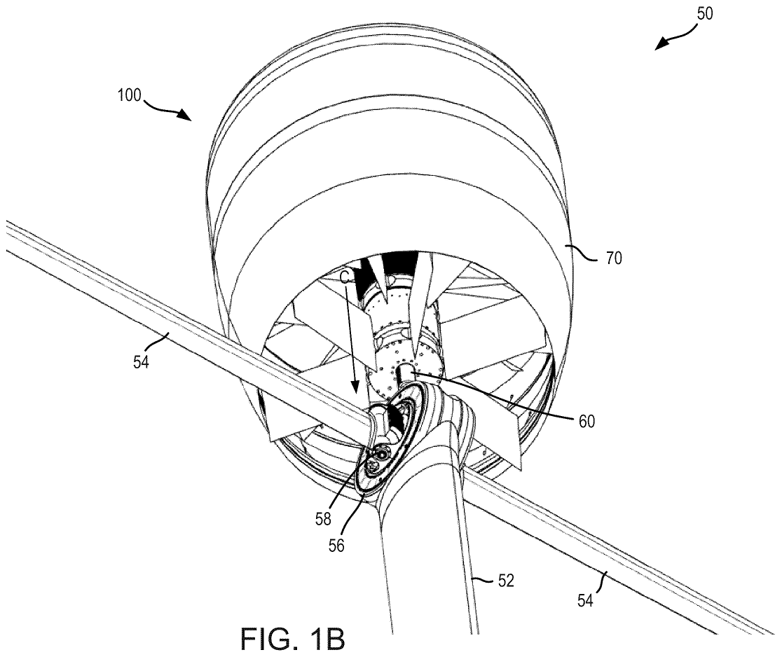

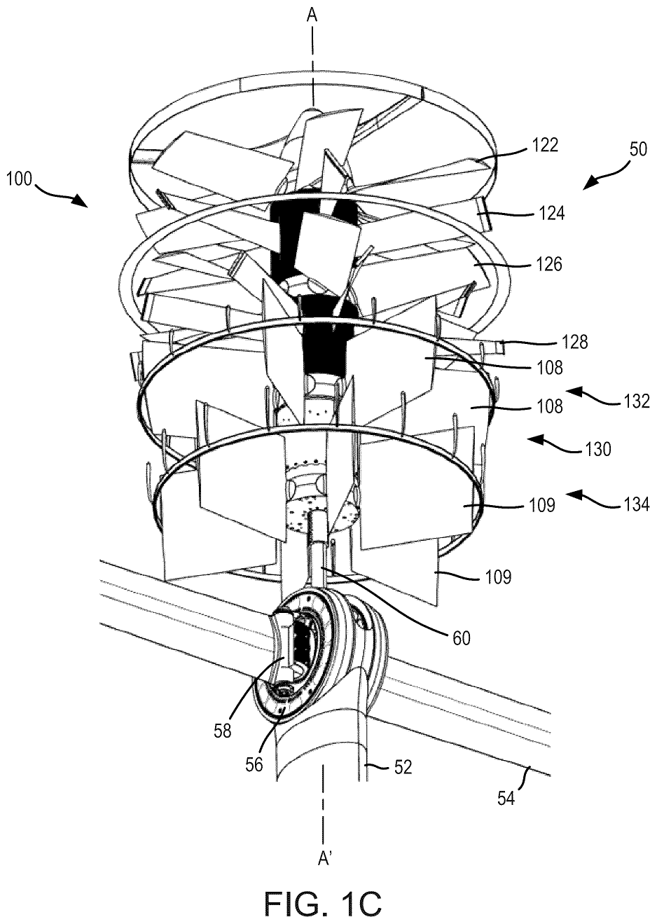

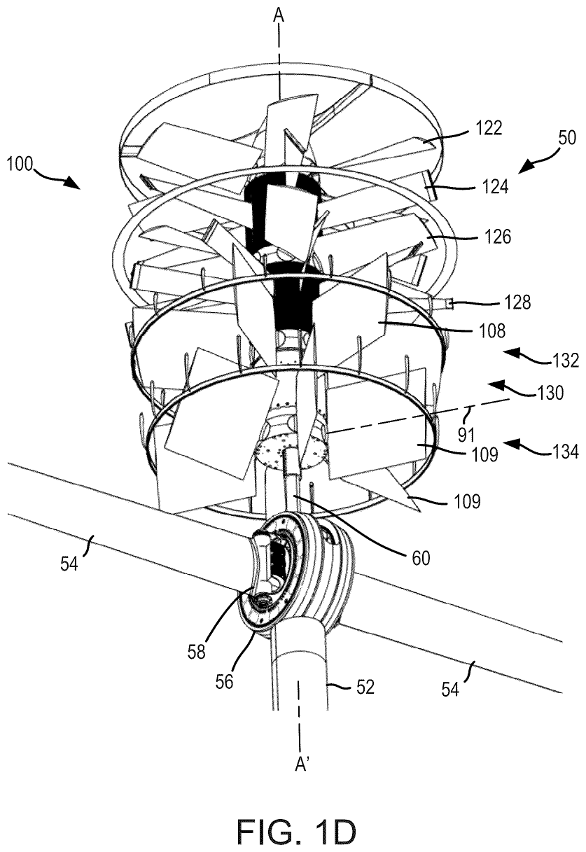

FIG. 1A through FIG. 1D illustrate a skyboom-based electric vertical takeoff and landing (eVTOL) aircraft 50. eVTOL aircraft 50 is an aircraft formed around a fuselage 52 (also referred to herein as a powerboom or skyboom). The top end of skyboom 52 has upper wings 54 attached via an articulated joint 56. Each upper wing 54 is attached to articulated joint 56 via a hinge 58. A rotor stanchion 60 extends from joint 56 and holds a propulsion system 100. The bottom end of skyboom 52 has lower wings 74 attached via articulated joint 76. Each lower wing 74 is attached to articulated joint 76 via a hinge 78. In this regard, articulated joint 56 may be disposed at a first end (also referred to herein as a top end or a front end) of skyboom 52 and joint 76 may be disposed at a second end (also referred to herein as a bottom end or an aft end) of skyboom 52. A payload connector 80 extends down from articulated joint 76. In various embodiments, payload connector 80 includes a shaft similar to stanchion 60 and can operate as a rudder with 360 degree rotation capability.

Skyboom 52 operates as the fuselage of eVTOL aircraft 50. The standard skyboom 52 can be 40 feet in length to support a combined wingspan of 160 feet for upper wings 54 and lower wings 74. In various embodiments, skyboom 52 acts as a torsion tube to accommodate differential loading between upper wings 54 and lower wings 74 (particularly when eVTOL aircraft 50 operates in rotorcraft mode). In the standard model, the combined wingspan of all four wings 54 and 74 is 100 feet: 60 feet for lower wings 74 and 40 feet for upper wings 54. Skyboom 52 houses fuel to power eVTOL aircraft 50. In the case of an all-electric eVTOL aircraft 50, skyboom 52 houses a large array of electric batteries. Standard battery weight for the all-electric eVTOL aircraft 50 can be 1,800-2,400 pounds, with an estimated total eVTOL weight of 3,600 to 4,000 pounds. The size, length, and battery capacity of skyboom 52 are all scalable as desired to meet flight requirements for a given situation. Skyboom 52 has a symmetric airfoil shape to provide a large battery storage capacity in a low drag structure. In hybrid embodiments, skyboom 52 can house both electric batteries and liquid fuel. In various embodiments, other types of power storage can be used as a power source for eVTOL aircraft 50, such as fuel cells and capacitors, among others.

eVTOL aircraft 50 has two pairs of long high aspect ratio wings, upper wings 54 at the top of skyboom 52 and lower wings 74 at the bottom of skyboom 52. In various embodiments, upper wings 54 are optional, and some embodiments are capable of horizontal cruising with only lower wings 74. In other embodiments, smaller canards are used for upper wings 54. Articulated joints 56 and 76 allow wings 54 and 74, respectively, to rotate about an axis through the lengths of the wings. Wings 54 and 74 are attached to circular rails, circular gears, or a ring gear within joints 56 and 76, respectively, that allow 360-degree rotation of the wings, about an axis down the length of the respective wings, using gears and electric drive motors. Rotation of wings 54 and 74 can also be passive. A locking mechanism can be used to temporarily disallow rotation of wings 54 and 74. Wings 54 and 74 may have additional control surfaces built into the wings, such as flaps or ailerons, for in-flight control. Otherwise, rotation via joints 56 and 76 can be used for in-flight control.

Articulated joint 56 allows wings 54 to rotate independently from each other. Articulated joint 76 allows wings 74 to rotate independently from each other. Rotating wings on opposite sides of skyboom 52 in opposite directions will effectively turn the wings into rotors to facilitate autorotation. In various embodiments, wing tips could be fitted with rockets to initiate autorotation. Rockets can be mounted directly to wing tips or within the wing structure with plumbing to a wing tip nozzle. In various embodiments, autorotation could be started by pressurized air jets. In various embodiments, autorotation could be started by rotating payload connector 80 (and the associated payload connected thereto if present), via articulated joint 76, which torque force is reacted through skyboom 52 causing the skyboom 52 and associated wings 54, 74 to counterrotate with respect to the payload connector 80. Autorotation can be particularly useful in reduced power or loss of power situations. In autorotation, the entire eVTOL aircraft 50 rotates, except for payload connector 80, in response to surrounding air moving upward relative to the eVTOL. In autorotation, skyboom 52 rotates about an axis through the length of the skyboom. An attached load could be geared through payload connector 80 to maintain set position or rotate in an opposite direction to induce a stabilizing effect.

Articulated joint 56 also allows stanchion 60, and thus propulsion system 100, to rotate relative to skyboom 52. As with wings 54, rotor stanchion 60 is attached to a circular rail or geared component within articulated joint 56 to allow rotation and may be powered by an electric drive motor and gears. Rotation of propulsion system 100 facilitates transition between horizontal and vertical flight by tilting thrust toward the desired direction of travel. Rotation of propulsion system 100 relative to skyboom 52 can be passive. With the rotor assembly dragging the skyboom behind, the wings provide lift to naturally bring eVTOL aircraft 50 into a horizontal posture. A locking mechanism (e.g., the collective cyclic-damping control mechanism(s) as described in greater detail herein) can be used to temporarily disallow rotation of propulsion system 100.

Articulated joint 76 allows connector 80 to rotate relative to skyboom 52. Connector 80 is attached to a circular rail or geared component within articulated joint 76 and powered by a driver motor and gears. Rotation of the connector 80 with respect to skyboom 52 can be passive, with a load causing connector 80 to remain hanging down vertically from articulated joint 76 as eVTOL aircraft 50 transitions between vertical and horizontal flight. When connector 80 is loaded and hangs down, the connector 80 stabilizes the flight of eVTOL aircraft 50 and functions as a tail rudder. When eVTOL aircraft 50 is unloaded, connector 80 can be extended upward or downward during horizontal flight as a vertical stabilizer. A locking mechanism can be used to temporarily disallow rotation of connector 80. The double-jointed design of eVTOL aircraft 50 with articulated joints at both ends allows counter-force to be applied to the propulsion system, reducing moments of instability during transition between horizontal and vertical flight.

The vertical design of eVTOL aircraft 50 with skyboom 52 provides a base structure to accommodate long folding wings 54 and 74 deployed from joints 56 and 76. Hinge 58 on joint 56 allows wings 54 to fold down onto skyboom 52, and hinge 78 on joint 76 allows wings 74 to fold up onto skyboom 52. In some embodiments, one or more sets of wings attached to skyboom 52 can be fixed rather than rotatable and foldable. Additional active wings, rudders, and other control surfaces can be mounted to skyboom 52 as desired for additional lift and control.

In some embodiments, upper wings 54, lower wings 74, or both can have a variable geometry. In one embodiment, hinges 78 allow lower wings 74 to sweep forward, in a similar rotation direction as classic variable sweep aircraft wings. Wings 74 would end up being oriented parallel to skyboom 52, but rotated approximately 90 degrees about an axis through the length of the wings so that the width of the wing extends out from the skyboom. Wings 74 would then operate similar to a long delta wing or chine. The tips of wings 74 can attach to the skyboom 52, so that articulated joint 76 warps wings 74 as a control surface. Upper wings 54 could be swept backwards similarly instead of or in addition to lower wings 74.

FIG. 1B, FIG. 1C, and FIG. 1D illustrate perspective views from below propulsion system 100 with duct 70 installed (see FIG. 1B) and with duct 70 omitted (see FIG. 1C and FIG. 1D) for ease of illustration. Propulsion system 100 includes one or more rotor blades 122, 126. Rotor blades 122, 126 may be mounted to and configured to rotate about stanchion 60. Propulsion system 100 can further include one or more stator vanes 124, 128.

Propulsion system 100 can further include a dual power turbine 130 comprising a first power turbine module 132 and a second power turbine module 134. Dual power turbine 130 can be located downstream from rotor blades 122, 126. First power turbine module 132 can include one or more turbine blades 108. Second power turbine module 134 can include one or more turbine blades 109. In various embodiments, the first power turbine module 132 can be located forward of second power turbine module 134. A first plurality of turbine blades 108 of first power turbine module 132 can be configured to rotate about axis A-A′ and a second plurality of turbine blades 109 of second power turbine module 134 can be configured to rotate about axis A-A'. In various embodiments, first plurality of turbine blades 108 is configured to rotate about axis A-A′ in a first rotational direction and second plurality of turbine blades 109 is configured to rotate about axis A-A′ in a second, opposite rotational direction. Stated differently, first plurality of turbine blades 108 and second plurality of turbine blades 109 may counterrotate about axis A-A′.

In various embodiments, turbine blades 108 are mounted to, and configured to rotate with, stanchion 60. In various embodiments, turbine blades 108 can be configured to rotated together with stanchion 60 with respect to propulsion system 100 (e.g., with respect to duct 70). In this manner, propulsion system 100 may drive rotation of the skyboom 52 by directing a core air flow through the core flow path C over the first plurality of turbine blades 108 and second plurality of turbine blades 109 to cause the first plurality of turbine blades 108 and second plurality of turbine blades 109 to rotate with respect to the propulsion system 100. Core air flows through propulsion system 100 (i.e., through duct 70) and is expelled from the duct 70 at an outlet or exit surrounding second plurality of turbine blades 109. In this regard, turbine blades 109 can be disposed at an outlet of the propulsion system 100 (i.e., at an outlet of the duct 70).

Propulsion system 100 can include a first set of rotor blades 122 and a second set of rotor blades 126 disposed axially from the first set of rotor blades 122. Rotor blades 122 and 126 may be mounted to and rotate about stanchion 60. Rotor blades 122 and 126 may be configured to counter-rotate to keep the overall combined rotational velocity of the rotor blades 122, 126 approximately zero. Stated differently, rotor blades 122 can be configured to rotate in a first rotational direction and rotor blades 126 can be configured to rotate in a second rotational direction, opposite the first rotational direction, at the same rotational velocity as the rotor blades 122. In various embodiments, the rotor blades 122 and 126 may be configured to co-rotate, wherein stabilization of the aircraft can be achieved with the turbine blades 108, 109. In an example embodiment, the individual rotor blades 122 and/or 126 are driven with one electric motor, or preferably with two or more electric motors stacked on a common shaft. Stacking electric motors provides redundancy and reduces magnetic saturation within the motors during high current draw situations. Stacking motors also allows switching between motors to reduce thermal loading and improve efficiency during horizontal winged flight. Propulsion system 100 may further include a shroud or duct 70 (also referred to as a nacelle) mounted to stanchion 60 and extending around blades 122, 126. Center attachment of the propulsion system tends to reduce weight and improve the stability and rigidity of duct 70. The rotor blades 122 and 126 drive air along a core flow path C defined by the duct 70 for compression and expansion through the duct for generating thrust for the eVTOL aircraft 50 and, when desired, driving rotation of the first plurality of turbine blades 108 and second plurality of turbine blades 109. In various embodiments, a first plurality of stator vanes 124 are disposed downstream from blades 122. Stator vanes 124 can be disposed between blades 122 and blades 126. In various embodiments, a second plurality of stator vanes 128 are disposed downstream from blades 126. Stator vanes 128 can be disposed between blades 126 and first power turbine module 132.

In various embodiments, first plurality of turbine blades 108 and second plurality of turbine blades 109 are configured to control movement of eVTOL aircraft 50 by displacing moving air from blades 122, 126. Stated differently, first plurality of turbine blades 108 and second plurality of turbine blades 109 may be configured to provide thrust vectoring. In various embodiments, a portion of each of the second plurality of turbine blades 109 may extend from the duct 70 to allow for greater directional vectoring. Positioning the second plurality of turbine blades 109 to extend from duct 70 tends to increase control of directional vectoring at the expense of performance when operating as a power turbine. In this regard, the percentage of turbine blade 109 disposed within the duct 70 versus the percentage of turbine blade 109 extending from the duct 70 may be optimized as desired. In various embodiments, more of the turbine blade 109 is disposed within duct 70 than that which extends from duct 70. In various embodiments, the turbine blades 108 and/or turbine blades 109 may be rotated about stanchion 60 to modify the direction that moving air is displaced relative to skyboom 52. Each turbine blade 108 and/or each turbine blade 109 may be rotated about a longitudinal axis through the lengths thereof (e.g., FIG. 1D illustrates turbine blade 109 rotated about a longitudinal axis 91 thereof). Each turbine blade 108 and/or each turbine blade 109 may be rotated independently of each other. In various embodiments, turbine blades 108 are rotated in a different direction as turbine blades 109 to spin eVTOL aircraft 50 in vertical flight. eVTOL aircraft 50 has high aspect ratio wings, an aerodynamic design, and large energy storage capacity within skyboom 52, which provide excellent efficiency and allows the eVTOL aircraft 50 to operate for long periods of time before needing recharging or refueling. The efficient aerodynamic design of the eVTOL aircraft 50 structure in combination with the unobstructed air flow around the propulsion system provide greater cruise and top speed capability independent of the chosen propulsion system. The noise reduction attributes of the ducted rotor propulsion design coupled with the propulsion system's location 40 feet or more above the payload combine to reduce noise levels. The location of the propulsion system and length of skyboom 52 allows for a long, efficient wingspan and larger diameter rotor blades 122, 126, whether ducted or not. The simple design of eVTOL aircraft 50 helps streamline the manufacture of carbon fiber components. However, eVTOL aircraft 50 is so efficient that the aircraft could also be made out of aluminum and still fly long enough on a single battery charge to be commercially viable. Moreover, any suitable material may be used to make the eVTOL aircraft 50.

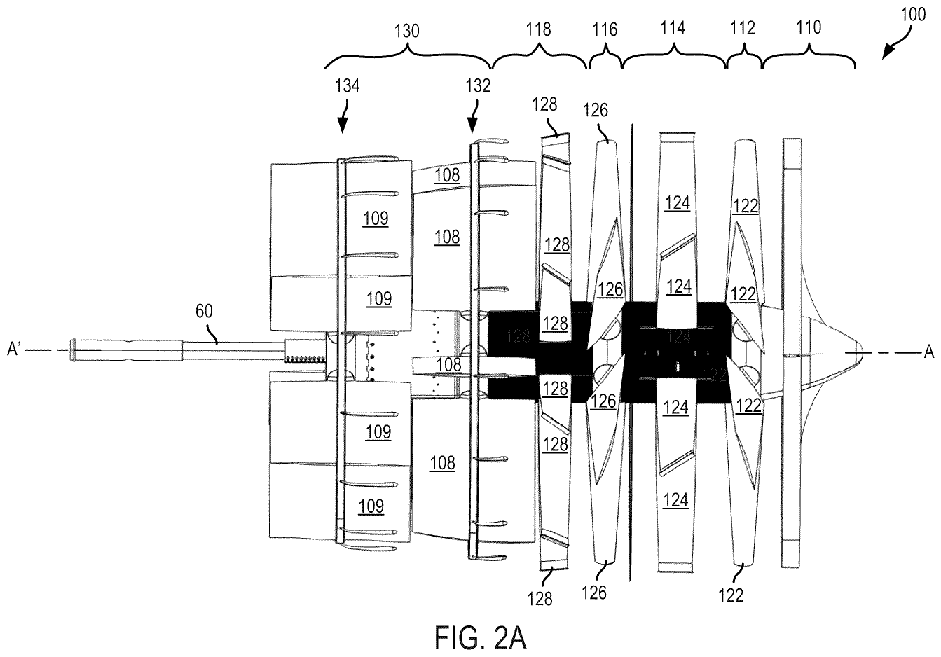

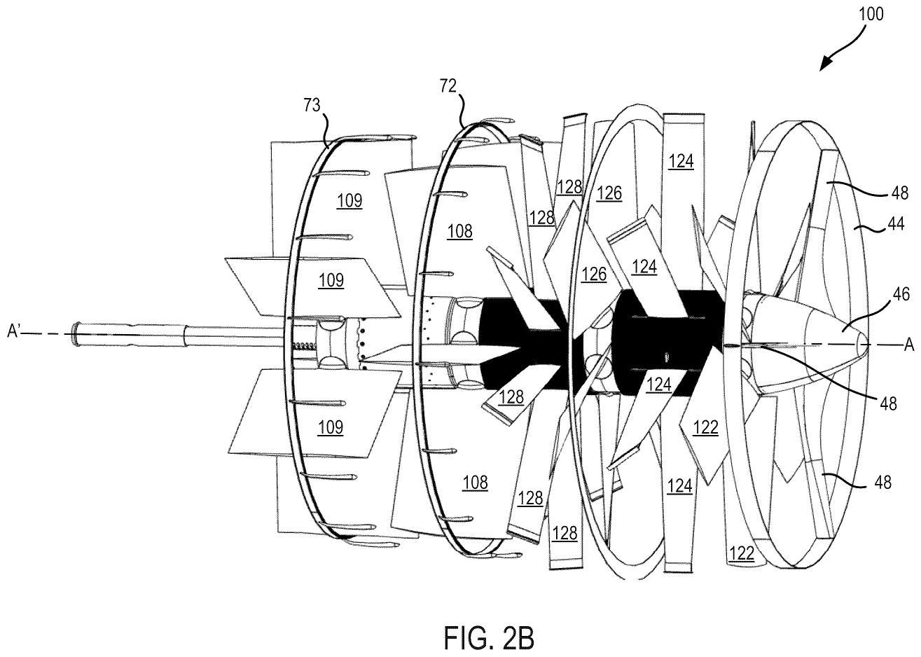

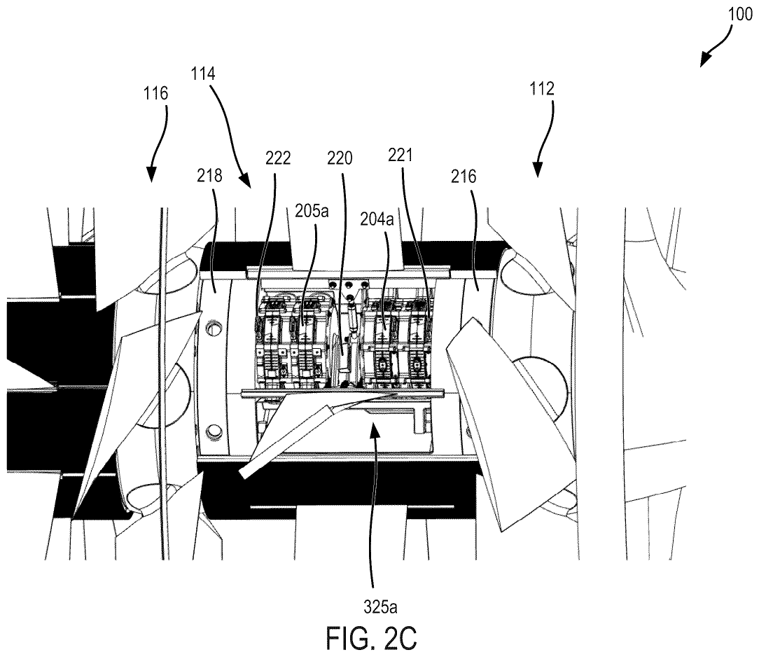

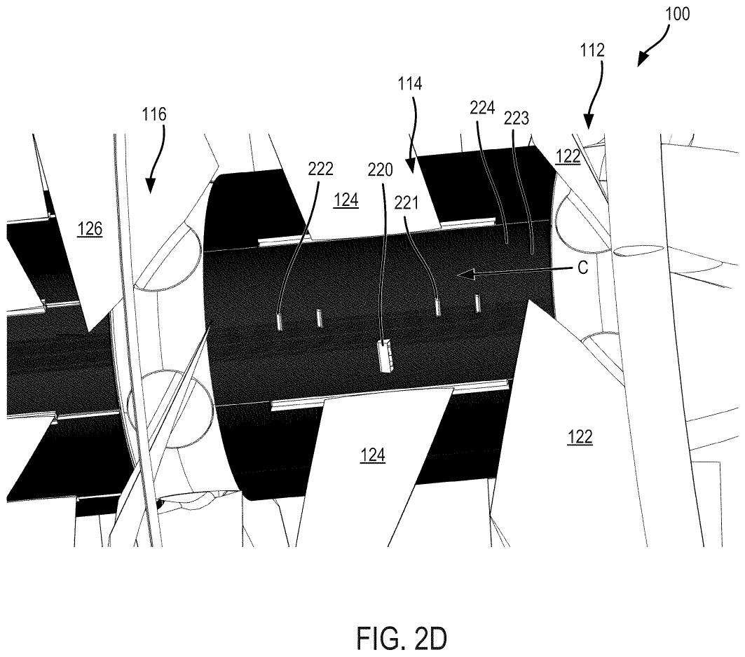

FIG. 2A is a side view of an electric propulsion system 100 with the duct 70 omitted for ease of illustration. Electric propulsion system 100 is illustrated as having a nose cone 110, a first turbine module 112, a motor module 114, a second turbine module 116, an electronics module 118, and a dual power turbine 130. Although illustrated as having two rotor/stator pairs, electric propulsion system 100 may have any number of rotors and/or stators as desired depending on desired payload capability, desired power capability, the diameter of the duct 70, and desired range capability, among other factors. Moreover, although illustrated without a duct (also referred to as a shroud), it is contemplated that electric propulsion system 100 may further include a duct coupled to the tips of stator vanes 124 and 128.

First turbine module 112 and second turbine module 116 may each comprise a plurality of turbine rotor blades 122 and 126, respectively. Rotor blades 122 and 126 may be disposed circumferentially about longitudinal axis A-A′. Rotor blades 122 and 126 may be configured to rotate about longitudinal axis A-A′.

Motor module 114 and electronics module 118 may each comprise a plurality of stator vanes 124 and 128, respectively. Stator vanes 124 and stator vanes 128 may be disposed circumferentially about longitudinal axis A-A′. In various embodiments, motor module 114 is disposed axially between turbine module 112 and turbine module 116. In various embodiments, motor module 114 is disposed axially aft of turbine module 112. In various embodiments, electronics module 118 is disposed axially aft of turbine module 116. In various embodiments, electronics module 118 is disposed axially between turbine module 116 and dual power turbine 130.

Dual power turbine 130 may comprise first power turbine module 132 and second power turbine module 134. First power turbine module 132 can include a plurality of turbine blades 108. Turbine blades 108 may be disposed circumferentially about longitudinal axis A-A′. Turbine blades 108 may be configured to rotate about longitudinal axis A-A′. Second power turbine module 134 can include a plurality of turbine blades 109. Turbine blades 109 may be disposed circumferentially about longitudinal axis A-A′. Turbine blades 109 may be configured to rotate about longitudinal axis A-A′. Turbine blades 108 and/or turbine blades 109 may be powered by aerodynamic forces of core air flow through propulsion system 100 acting on the turbine blades 108 and/or turbine blades 109 to cause stanchion 60 (and wings 54, 74 and skyboom 52) to rotate about longitudinal axis A-A′.

FIG. 2B is a perspective view of the propulsion system 100 with the duct 70 omitted for ease of illustration, in accordance with various embodiments. Propulsion system 100 can include nose cone inlet stator vanes 48 extending between and to nose cone 46 and inlet stator vane ring 44. The nose cone inlet stator vanes 48 may provide multiple wiring pathways for various components as desired. Inlet stator vane ring 44 may be coupled to duct 70. The nose cone inlet stator vanes 48 may provide axial support to the duct 70. Inlet stator vane ring 44 may provide structural support for nose cone inlet stator vanes 48. Propulsion system 100 can include one or more floating air bearings, such as floating air bearing 72 and floating air bearing 73, which are described in further detail herein.

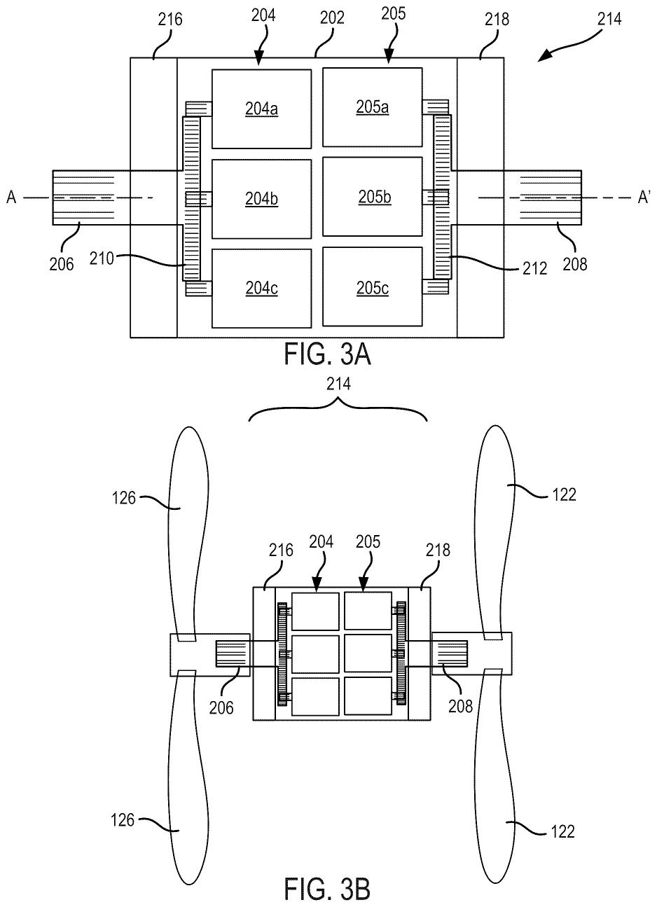

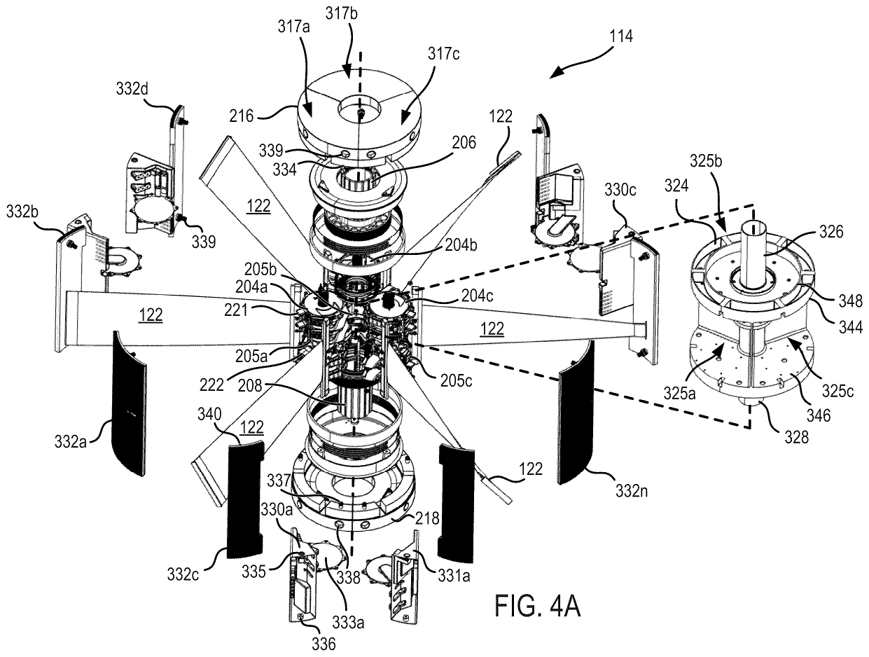

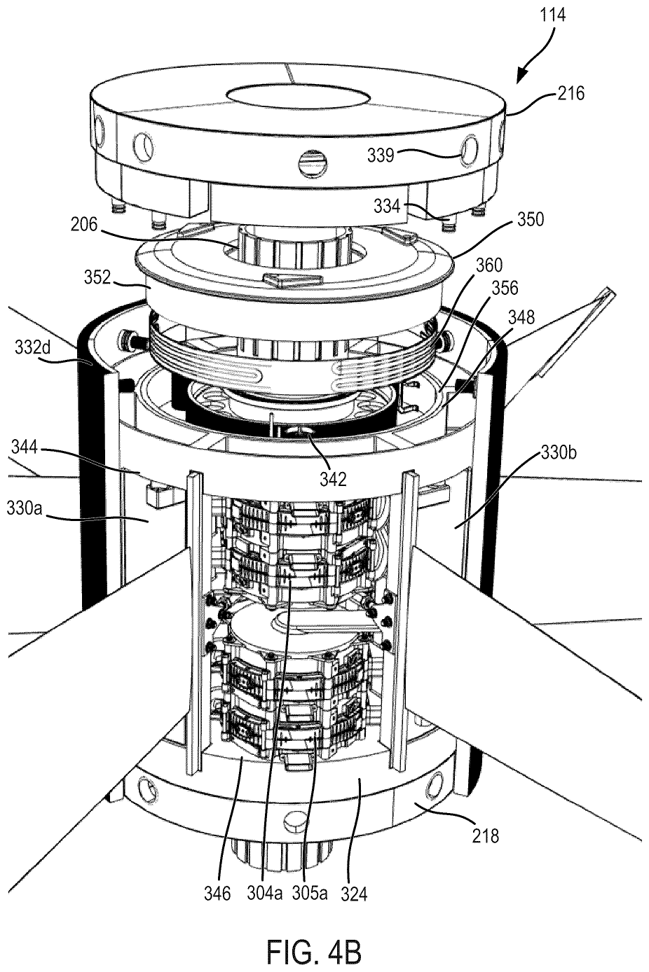

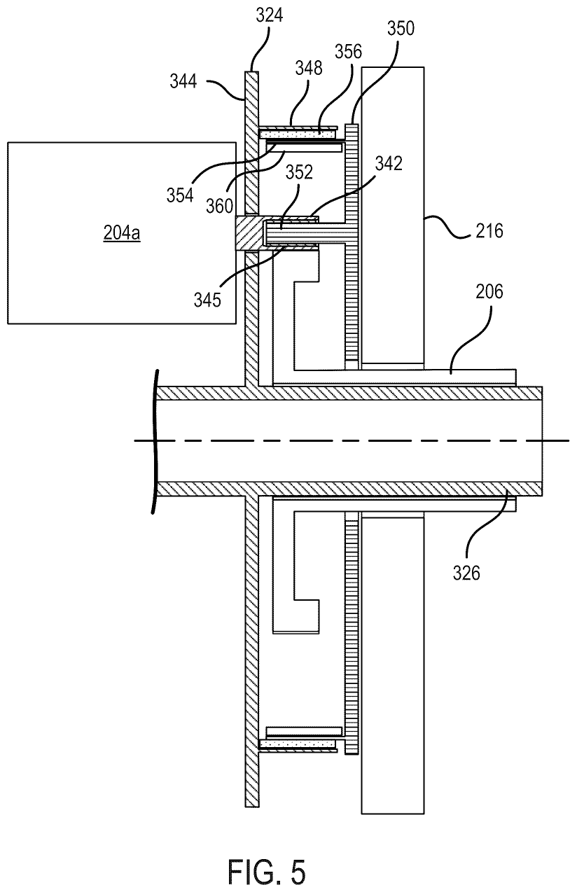

FIG. 2C is an enlarged view of motor module 114 installed in the electric propulsion system 100 with a motor module cover 223 (also referred to as an inner cowl or a heat exchanger) omitted to expose motor 204a and motor 205a for ease of illustration, in accordance with various embodiments. While motor 204a and motor 205a are exposed in FIG. 2C, it should be understood that motor 204a can be one of a plurality of motors disposed circumferentially about a first output shaft and motor 205a can be one of a plurality of motors disposed circumferentially about a second output shaft, as described herein with respect to FIG. 3A, FIG. 3B, and FIG. 4A through FIG. 5.

Motor module 114 can include a first coolant reservoir 216 and a second coolant reservoir 218. Motor module 114 can define a plurality of cavities. As best seen in FIG. 4A and FIG. 4B, motor module 114 can comprise a center frame 324 at least partially defining a plurality of cavities (e.g., first cavity 325a, second cavity 325 b, and third cavity 325c; also referred to herein as motor cavities). In various embodiments, first cavity 325a is fluidly sealed from second cavity 325b and third cavity 325c. In various embodiments, second cavity 325b is fluidly sealed from third cavity 325c. In this manner, motor module 114 can be logically divided into a plurality of sections for providing motive power and cooling, among other logically divided controls. For example, coolant reservoir 216 can similarly be subdivided into three cavities (e.g., cavity 317a, cavity 317b, and cavity 317c). Each cavity 317a, 317b, and 317c can be fluidly sealed from the other cavities (i.e., first cavity 317a is fluidly sealed from second cavity 317b and third cavity 317c and second cavity is fluidly sealed from third cavity 317c). Coolant reservoir 218 can similarly be subdivided into three cavities. In this manner, independent cooling flow paths and/or motor control can be formed for each cavity or section of the motor module 114. Moreover, although illustrated as divided into three cavities, coolant reservoir 218 can be subdivided into any suitable number of cavities as desired. In this manner, a motor or coolant failure in one cavity may not affect the operation of the motors and/or cooling of the other cavities. Subdividing motor module 114 into a plurality of logically divided cavities or sections tends to improve the robustness of motor module 114.

FIG. 3A schematically illustrates an exemplary motor module 214 for an electric turbine (e.g., propulsion system 100 disclosed herein), in accordance with various embodiments. In various embodiments, motor module 114 (see FIG. 2A) is similar to motor module 214. Motor module 214 generally comprises a housing 202, a first plurality of electric motors 204 (e.g., first electric motor 204a, second electric motor 204b, and third electric motor 204c), a first output shaft 206 operatively coupled to the first plurality of electric motors 204, a second plurality of electric motors 205 (e.g., first electric motor 205a, second electric motor 205 b, and third electric motor 205c), and a second output shaft 208 operatively coupled to the second plurality of electric motors 205. In various embodiments, motors 204 and motors 205 are direct current (DC) electric motors. In various embodiments, motors 204 and motors 205 are permanent magnet direct current (PMDC) electric motors.

In various embodiments, first output shaft 206 is driven by plurality of electric motors 204. For example, first output shaft 206 may comprise a gear 210 configured to be driven by electric motors 204. In various embodiments, electric motors 204 are meshingly engaged to gear 210 (e.g., all of the electric motors 204 are meshingly engaged to the same gear 210). In this manner, the input torque into first output shaft 206 may be divided among electric motors 204. Second output shaft 208 may be similarly driven by plurality of electric motors 205. For example, second output shaft 208 may comprise a gear 212 configured to be driven by electric motors 205. In various embodiments, electric motors 205 are meshingly engaged to gear 212 (e.g., all of the electric motors 205 are meshingly engaged to the same gear 212). In this manner, the input torque into second output shaft 208 may be divided among electric motors 205. In various embodiments, first output shaft 206 and second output shaft 208 are configured to rotate about a common axis A-A′.

Motor module 214 can further include a first coolant reservoir 216 disposed at a first end of the motor module 214. Motor module 214 can further include a second coolant reservoir 218 disposed at a second end of the motor module 214. Motors 204, 205 can be disposed between first coolant reservoir 216 and second coolant reservoir 218. First coolant reservoir 216 and/or second coolant reservoir 218 can contain a coolant (e.g., a liquid such as a light oil, glycol, or the like) for cooling motors 204 and/or motors 205. Moreover, the coolant contained by first coolant reservoir 216 and/or second coolant reservoir 218 can provide cooling for other electronics onboard the propulsion system 100 (see FIG. 3A). Coolant can be moved from first coolant reservoir 216, through one or more components to be cooled (e.g., motors 204 and/or motors 205), and into second coolant reservoir 218. Coolant can be returned to first coolant reservoir 216 from the second coolant reservoir 218 through one or more components to be cooled (e.g., motors 204 and/or motors 205). In this regard, a coolant flow path loop can be formed between first reservoir 216 and second reservoir 218 for cooling motors 204, 205. In various embodiments, output shaft 206 can extend through first coolant reservoir 216. In various embodiments, output shaft 208 can extend through second coolant reservoir 218.

FIG. 3B schematically illustrates motor module 214 with rotor blades 126 coupled to, and configured to rotate with, first output shaft 206 and rotor blades 122 coupled to, and configured to rotate with, second output shaft 208. In various embodiments, first output shaft 206 is configured to counter rotate with respect to second output shaft 208 (i.e., first output shaft 206 is configured to rotate in an opposite rotational direction as that of second output shaft 208). In this manner, the rotational velocity of rotor blades 126 and 122 can be controlled by electric motors 204 and 205, respectively. In this regard, motor module 214 may be provided for powering a first turbine module and a second turbine module. The first and second turbine modules can be disposed at opposite ends of the motor module 214.

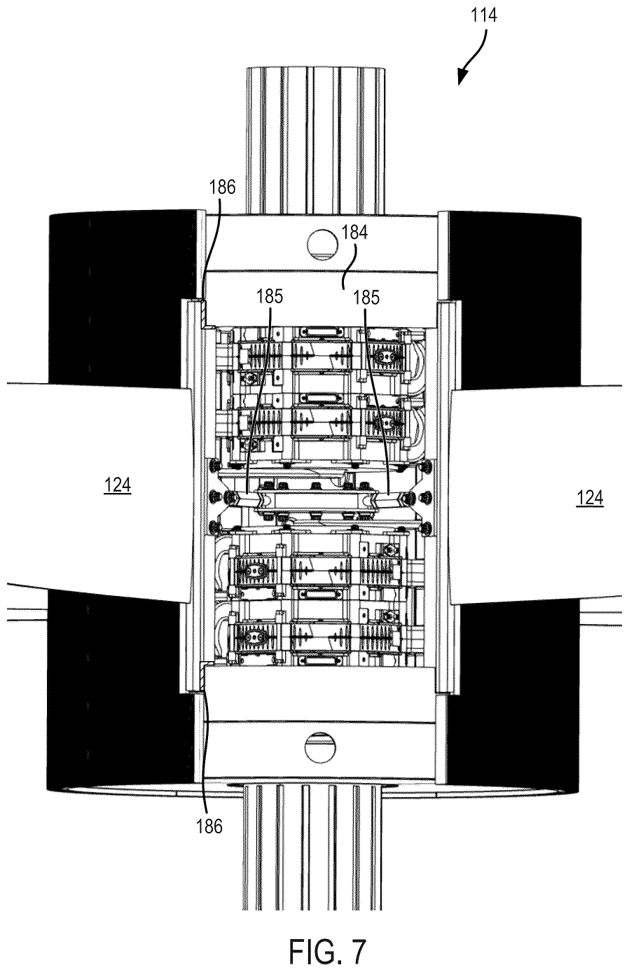

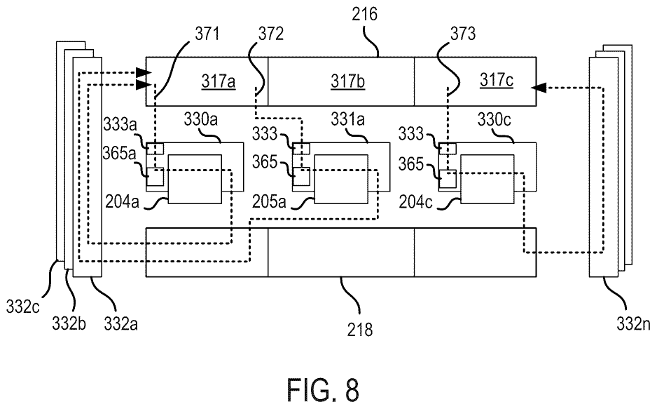

With combined reference to FIG. 4A and FIG. 8, motor module 114 further comprises a plurality of heat exchangers (e.g., heat exchanger 332a, heat exchanger 332b, heat exchanger 332c, etc.) disposed circumferentially about motor module 114 and at least partially defining a core flow path through propulsion system 100. The heat exchangers can be configured to transfer heat from the coolant to the core air flow for providing cooling to various propulsion system components. Moreover, the heat exchangers (e.g., heat exchanger 332a, heat exchanger 332b, heat exchanger 332c, etc.) can at least partially enclose and/or seal each of the cavities (e.g., cavity 325a, cavity 325b, and cavity 325c) of the center frame 324. As best seen in FIG. 8, a first coolant flow path 371 for a first motor (e.g., electric motor 204a) can be formed from a first cavity 317a of the first coolant reservoir 216 to a motor control housing 330a, from the motor control housing 330a through the motor 204a (e.g., the motor stator), from the motor 204a back into motor control housing 330a, from motor control housing 330a into coolant reservoir 218, and from coolant reservoir 218 into at least one heat exchanger (e.g., heat exchanger 332a, heat exchanger 332b, and/or heat exchanger 332c) where heat is removed from the coolant into core flow path air through propulsion system 100. The coolant can be directed through the heat exchanger 332a, 332b, and/or 332c and back into coolant reservoir 216 where it can then be recycled through the first coolant flow path 371. Motor control housing 330a can house control electronics 365a for motor 204a and/or pump 333a that can be cooled by the coolant in the first coolant flow path 371. Motor control housing 330a can house a pump 333a for circulating the coolant through the first coolant flow path 371. In various embodiments, control electronics 365a regulate a temperature of motor 204a and control pump 333a to provide cooling to motor 204a. In various embodiments, control electronics 365a control a rotational speed of motor 204a. Motor control housing 331a can similarly house control electronics (referred to herein generally as control electronics 365) for motor 205a and/or a second pump (referred to herein generally as second pump 333). Likewise, motor control housing 330c can similarly house control electronics (referred to herein generally as control electronics 365) for motor 204c and/or a third pump (referred to herein generally as third pump 333).

A second coolant flow path 372 for a second motor (e.g., electric motor 205a) can be formed from first cavity 317a of the first coolant reservoir 216 to a motor control housing 331a, from the motor control housing 331a through the motor 205a (e.g., the motor stator), from the motor 205a back into motor control housing 331a, from motor control housing 331a into coolant reservoir 218, and from coolant reservoir 218 into at least one heat exchanger (e.g., heat exchanger 332a, heat exchanger 332b, and/or heat exchanger 332c) where heat is removed from the coolant into core flow path air through propulsion system 100. The coolant can be directed through the heat exchanger 332a, 332b, and/or 332c and back into coolant reservoir 216 where it can then be recycled through the second coolant flow path 372. Motor control housing 331a can house motor control electronics for motor 205a that can be cooled by the coolant in the second coolant flow path 372.

Additional coolant flow paths can similarly be provided for motor 204b and motor 205b via second cavity 317b of coolant reservoir 216. Moreover, additional coolant flow paths can similarly be provided for motor 204c and motor 205c via third cavity 317c of coolant reservoir 216. For example, with momentary reference to FIG. 8, a third coolant flow path 373 for motor 204c can be formed from third cavity 317c of the first coolant reservoir 216 to a motor control housing 330c, from the motor control housing 330c through the motor 204c, from the motor 204c back into motor control housing 330c, from motor control housing 330c into coolant reservoir 218, and from coolant reservoir 218 into at least one heat exchanger (e.g., heat exchanger 332n) where heat is removed from the coolant into core flow path air through propulsion system 100. The coolant can be directed through the heat exchanger 332n and back into coolant reservoir 216 where it can then be recycled through the third coolant flow path 373.

With reference again to FIG. 4A and FIG. 4B, first coolant reservoir 216 can include a first outlet 334 and motor control housing 330a can include an inlet 335 whereby the motor control housing 330a is fluidly coupled to the first coolant reservoir 216. Coolant can flow axially (i.e., parallel to axis A-A′) through first outlet 334 in accordance with various embodiments. Motor control housing 330a can include an outlet 336 and second coolant reservoir 218 can include a first inlet 337 whereby the motor control housing 330a is fluidly coupled to the second coolant reservoir 218. Second coolant reservoir 218 can include a first outlet 338 and heat exchanger 332c can include an inlet (e.g., similar to inlet 339 of heat exchanger 332d) whereby the heat exchanger 332c is fluidly coupled to the second coolant reservoir 218. Coolant can flow radially (i.e., perpendicular to axis A-A′) through first outlet 338 in accordance with various embodiments. First coolant reservoir 216 can include a first inlet 339 and heat exchanger 332c can include an outlet 340 whereby the heat exchanger 332c is fluidly coupled to the first coolant reservoir 216. Coolant can flow radially (i.e., perpendicular to axis A-A′) through outlet 340 in accordance with various embodiments. Having described various ports (e.g., inlets and outlets) for the first cooling flow path, it should be understood that coolant reservoir 216 and coolant reservoir 218 comprises a plurality of inlets and outlets for forming a plurality of cooling flow paths from and between the various motors and heat exchangers, for example as illustrated in FIG. 8, each of which will not be explained in detail for sake of brevity. The various inlets and/or outlets are disposed circumferentially about coolant reservoir 216 and coolant reservoir 218 for forming a plurality of flow paths therebetween for independent cooling of each of the motors and their respective control electronics.

With reference again to FIG. 2C and FIG. 2D, a ram air inlet port 220 can extend into the core air flow path (see core flow path C of FIG. 1A) of the propulsion system 100 to scoop air into cavity 325a. For example, one or more ram air inlet ports can be provided for each cavity of the motor module 114. In response to the propulsion system starting up, core air flow is directed through propulsion system 100 and each cavity (e.g., cavity 325a) can be pressurized by air being scooped into the cavity via its respective ram air inlet port (e.g., ram air inlet port 220). In this regard, each ram air inlet port 220 can face forward into the oncoming core air flow. Each cavity can be fluidly sealed off (e.g., in the boom 52 where the wires come in to power the propulsion system). Cooling air can be forced through each motor (e.g., motor 204a, 204b, 204c, 205a, 205b, and 205c) to provide additional cooling thereto. The cooling air can escape through each motor back into the core air flow via a ram air exhaust port (e.g., ram air exhaust port 221 and/or ram air exhaust port 222). In this regard, the ram air exhaust ports 221 can extend from a respective motor casing. In various embodiments, ram air exhaust port 221 and ram air exhaust port 222 are flush with motor module cover 223; though in various embodiments, ram air exhaust port 221 and ram air exhaust port 222 can be recessed in motor module cover 223 or extend slightly from ram air exhaust port 221 and ram air exhaust port 222. In various embodiments, ram air exhaust port 221 and ram air exhaust port 222 are circumferentially offset from ram air inlet port 220 so as to not aerodynamically interfere with each other and risk recirculation of hot air. Motor module cover/heat exchanger 332 may comprise an outer aerodynamic surface 224 in fluid communication with the core air flow C. Stated differently, motor module cover/heat exchanger 332 may at least partially define the core flow path through propulsion system 100.

With reference again to FIG. 4A, a first spindle 326 can extend from a first end of center frame 324. A second spindle 328 can extend from a second end of center frame 324. A first output shaft 206, operatively coupled to the first plurality of motors (e.g., motors 204a, 204b, and 204c), can rotate about first spindle 326. A second output shaft 208, operatively coupled to the second plurality of motors (e.g., motors 205a, 205b, and 205c), can rotate about second spindle 328. In various embodiments, the electric motors (e.g., motor 204a, 204b, 204c, 205a, 205b, and 205c) can be mounted to center frame 324.

With combined reference to FIG. 4B and FIG. 5, output shafts (e.g., see output shaft 342) for each motor (e.g., motor 204a, motor 204b, and motor 204c) can extend through an end plate 344 of center frame 324 to meshingly engage output shaft 206. End plate 344 can extend radially outward from spindle 326. Output shafts for each motor (e.g., motor 205a, motor 205b, and motor 205c) can similarly extend through an opposite end plate 346 of center frame 324 to meshingly engage output shaft 208 (see FIG. 4A). End plate 346 can extend radially from the second spindle 328.

A flange 348 can extend axially from end plate 344. In various embodiments, flange 348 is a cylindrical tube extending radially from end plate 344. In various embodiments, flange 348 is concentric with spindle 326. Flange 348 can at least partially surround spindle 326.

In various embodiments, a harmonic damper 350 is provided for reducing or eliminating resonance harmonics (e.g., vibration) in the system. With momentary reference to FIG. 5, a section view of harmonic damper 350 in an installed position with respect to motor 204a, harmonic damper 350, and center frame 324 is schematically illustrated, in accordance with various embodiments. It should be understood that electric motors 204b and 204c are similarly connected to harmonic damper 350 and output shaft 206. Harmonic damper can comprise a plurality of posts (e.g., post 352), each configured to extend into an output shaft of a respective motor. For example, post 352 can be configured to extend into output shaft 342 of motor 204a. The posts can be disposed circumferentially about harmonic damper 350 to align with each of the output shafts of the electric motors (e.g., electric motors 204a, 204b, and 204c). A bearing (e.g., bearing 345) can be disposed inside of each output shaft (e.g., output shaft 342) to reduce friction between post 352 and output shaft 342. Loads can be transferred between output shaft 342 and post 352 via bearing 345 to reduce or eliminate resonance harmonics of the system during operation. In various embodiments, bearing 345 is a needle bearing, a ball bearing, or the like.

In various embodiments, a damper ring 356 can be provided between a flange 354 of the harmonic damper 350 and flange 348. Flange 354 can be disposed radially inward from flange 348. Flange 354 can be disposed concentric with flange 348. Damper ring 356 can be compressed between flange 354 and flange 348 in various embodiments. Damper ring 356 can transfer loads between flange 354 and flange 348 in various embodiments. Damper ring 356 can be made from an elastomeric material (e.g., polytetrafluoroethylene or the like) configured to absorb vibrational energy (e.g., movement) of flange 354 with respect to flange 348.

In various embodiments, an oil cooler 360 can be disposed within flange 354 for cooling gear oil in fluid communication with output shaft 342. Oil cooler 360 can be in fluid communication with an oil pump for circulating a lubricating fluid (e.g., gear oil) to exchange heat from the lubricating fluid to a location outside of the harmonic damper (e.g., to the coolant in coolant reservoir 216 for example). For example, coolant in coolant reservoir can flow across lines from oil cooler 360 carrying a hot lubricating fluid to transfer heat from the hot lubricating fluid to the coolant whereby the heat is transferred to the core air flow, as described herein.

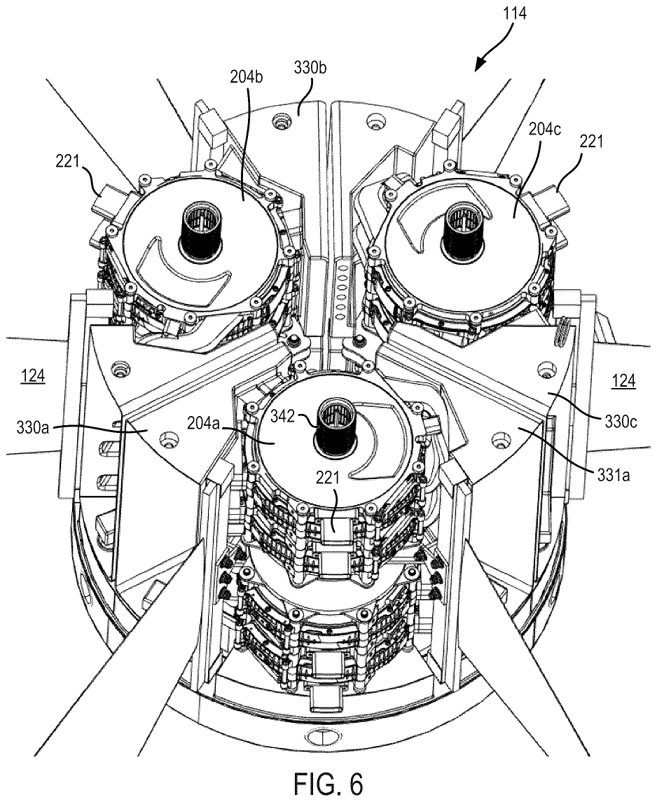

FIG. 6 illustrates a perspective view of electric motors 204a, 204b, 204c in an installed position with respect to their respective motor control housings (e.g., see motor control housing 330a for motor 204a). Motor 204b similarly has a motor control housing 330b and motor 204c similarly has a motor control housing 330c.

FIG. 7 illustrates the inboard end of stator vanes 124 coupled to the motor housing 184 of the motor module 114. Turnbuckles 185 may be connected to the inboard end of the stator vanes 124 to provide tension thereto. Each turnbuckle 185 may be connected between the respective stator vane 124 and the motor housing 184. Shims 186 may be used at the inboard ends of the stator vanes 124 for positioning and alignment of the stator vanes 124 with respect to the motor housing 184.

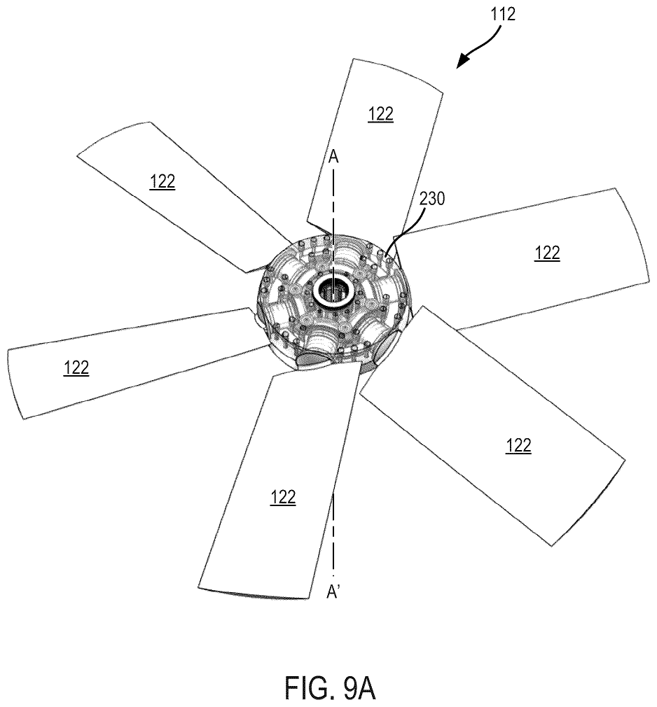

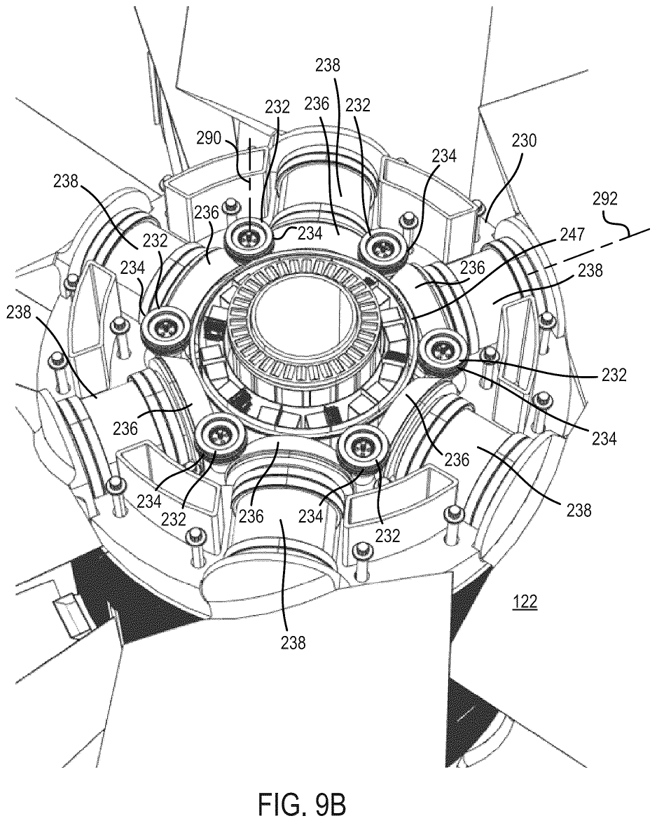

FIG. 9A is a perspective view of turbine module 112, in accordance with various embodiments. Turbine module 116 (see FIG. 2A) may be structurally and functionally similar to turbine module 112. Turbine module 112 generally comprises a center case 230 configured to rotate about longitudinal axis A-A′. Rotor blades 122 may be pivotally mounted to center case 230. Stated differently, rotor blades 122 may be rotated about an axis through the lengths of the rotor blades 122.

FIG. 9B is an enlarged view of the center case 230 with a cover plate of the center case 230 removed for ease of illustration. Each rotor blade 122 may be coupled to a motor 232. The motors 232 may be electric motors. The motors 232 may be globoid motors in various embodiments. The motors 232 can be mounted to center case 230. Each motor 232 may comprise a driving gear 234 configured to meshingly engage with a driven gear 236 of the respective rotor blade 122. Each driving gear 234 may be configured to rotate about an axis (e.g., axis 290) that is perpendicular to an axis (see axis 292) of rotation of the rotor blades 122. In various embodiments, axis 290 is parallel to longitudinal axis A-A′ (see FIG. 2).

In various embodiments, a timing ring 247 meshingly engages each of the driving gears 234 to maintain synchronous motion of the motors. Timing ring 247 can rotate about the propulsion system longitudinal axis (axis A-A′) when the driving gears 234 rotate about their respective axes 290.

In various embodiments, driven gear 236 rotates together with rotor blade 122. In various embodiments, driven gear 236 and rotor blade 122 are formed as a single piece of material. In various embodiments, driven gear 236 is removably coupled to rotor blade 122. For example, driven gear 236 may be formed onto a sleeve 238 which is then placed over the barrel of the rotor blade 122. Stated differently, each sleeve 238 may have driven gear 236 formed integrally (e.g., monolithically) thereon. Each sleeve 238 may be held in placed with a tendon molded into the rotor blade 122. Each sleeve 238 may be coupled to the rotor blade 122 via a splined connection or the like such that the sleeve 238 rotates together with the rotor blade 122. Thrust bearings and/or radial bearings may be placed on the sleeve 238 before assembly to allow for smooth rotation of the sleeve 238 with respect to center case 230.

In various embodiments, each motor 232 is coupled between two rotor blades 122. More particularly, each driving gear 234 may meshingly engage two different driven gears 236 located on opposite sides of the driving gear 234. In various embodiments, each driving gear 234 comprises bi-directional threads (i.e., a left-hand thread machined over a right-hand thread) to allow the driving gears 234 and the driven gears 236 to turn in the same direction. Stated differently, rotation of driving gear 234 in a single rotational direction causes the two rotor blades 122 meshingly engaged on opposite sides therewith to rotate in the same rotational direction, whereas without bidirectional threads, the two rotor blades 122 would tend to rotate in opposite directions. Moreover, providing two motors 232 per rotor blade 122 may allow for increased torque and quick rotation of rotor blades 122 which may be under heavy aerodynamic loads during operation.

In various embodiments, motors 232 are direct current (DC) electric motors. In various embodiments, motors 232 are permanent magnet direct current (PMDC) electric motors. In various embodiments, when motor 232 is a PMDC electric motor, as the motor 232 spins it generates a voltage proportional to its rotational speed. Not to be bound by any theory, this is a result of Faraday′s Law, which says that moving a wire through a magnetic field induces a voltage in it proportional to its velocity, and occurs whether it is driven by an external force or by its own power. Depending on how it is constructed (number of turns, size, stator or armature slots, magnet poles, etc.) each motor 232 may have a characteristic ‘Kv’ (Velocity constant), commonly expressed in rad/s/Volt or rpm/Volt. Again, not to be bound by any theory, the output torque of motors 232 may be proportional to the electric current supplied to the motors 232, according to Lorentz force law, which says that the magnetic force on a wire is proportional to current times magnetic field strength (which is constant in a permanent magnet or shunt wound DC motor). For a particular motor this relationship is a constant, called Kt (Torque constant), often expressed in Nm/A. By symmetry, Kt is the inverse of Kv. For this simplified example, any internal losses due to magnetic hysteresis, eddy currents, and friction and air drag will be ignored. If the motor has no load, then torque and current are zero, and no voltage is dropped across the armature resistance. However, in response to an external torque load on the motor 232, the motor 232 will slow down and produce less voltage, causing voltage to be dropped across the armature. Again, not to be bound by any theory, by Ohms Law a current must then flow, producing torque. Rotational speed of the motor 232 may continue to drop and the electric current may rise until output torque matches the externally applied torque. In this regard, motors 232 may mirror external torque forces. The more torque load is applied to the motor 232 the more current motor 232 may draw to match the torque load.

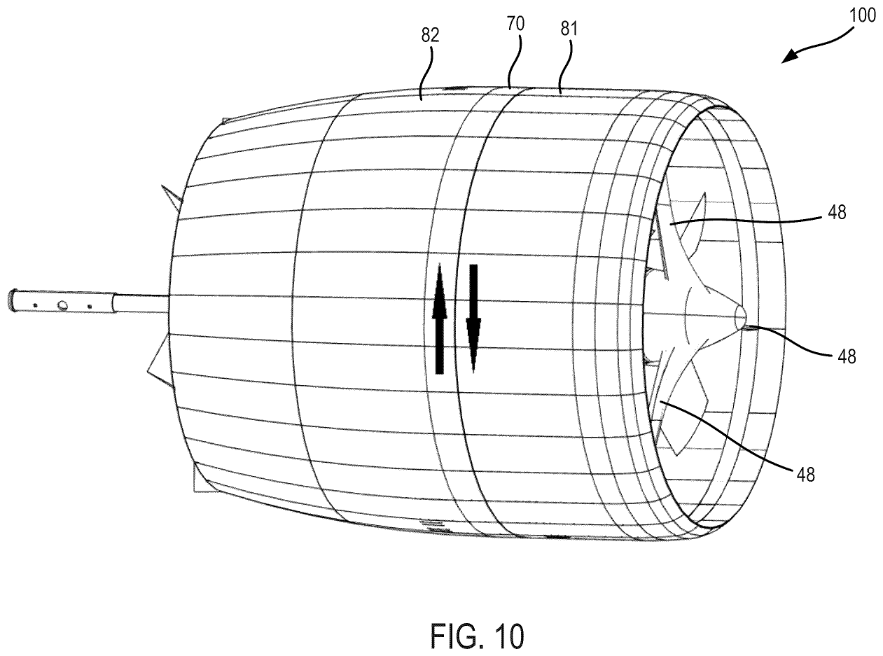

FIG. 10 is a perspective view of the propulsion system 100, in accordance with various embodiments. In various embodiments, duct 70 includes a first half 81 (which may be referred to as an upper half or a forward half) and a second half 82 (which may be referred to as a lower half or an aft half). To reduce radial flexing, the first and second ducts 81 and 82 may be rotated opposite one another to impart a counter torque. With momentary reference to FIG. 2B and FIG. 10, the tips of stator vanes 124 may be coupled to first half 81 and the tips of stator vanes 128 may be coupled to second half 82. The first and second ducts 81 and 82 may be rotated opposite one another to apply tension and/or sweep (i.e., bent along the circumferential direction) to stator vanes 124 and/or stator vanes 128. This opposed counter torque tends to aid in stabilizing the duct 70. Rotating the duct halves 81 and 82 opposite one another tends to cause a compound helical twist in the stator vanes 124 and 128 resulting in improved air flow. Stated differently, the tips of stator vanes 124 can move or bend with the first half 81 as the first half 81 rotates about the longitudinal axis A-A′ and the tips of stator vanes 128 can move or bend with the second half 82 as the second half 82 rotates in the opposite rotational direction about the longitudinal axis A-A′. In various embodiments, tension and/or vane sweep are set during installation. In various embodiments, first half 81 and second half 82 are slidingly coupled to one another such that the two halves 81 and 82 may rotate with respect to one another (e.g., within a predetermined rotational distance) to allow the duct 70 to vary tension and/or sweep under load during operation of propulsion system 100. Counterrotating first half 81 with respect to second half 82 tends to improve rigidity of duct 70 as a result of the tension in stator vanes 124 and/or stator vanes 128. Moreover, manufacturing the duct 70 as two separate parts allows the duct 70 to be placed over an assembled propulsion system.

In various embodiments, duct 70 is a non load bearing lightweight tensile structure. The compact nature of the electric propulsion system can provide space within the duct 70 for large power turbine blades. The inlet stator vanes 48 can provide axial support and multiple wiring pathways. The two-part design of duct 70 tends to reduce manufacturing and assembly time. For example, the stators can be bonded to duct 70 during the manufacturing process and the duct halves can then be fitted over the assembled propulsion system from either end and fastened in place via the turnbuckles. Duct 70 can be optimized for wing-borne cruise on the light cargo/passenger drones operating primarily as STOL aircraft. Duct 70 can be optimized for VTOL (vertical takeoff and landing) on the heavy-lift cargo drones.

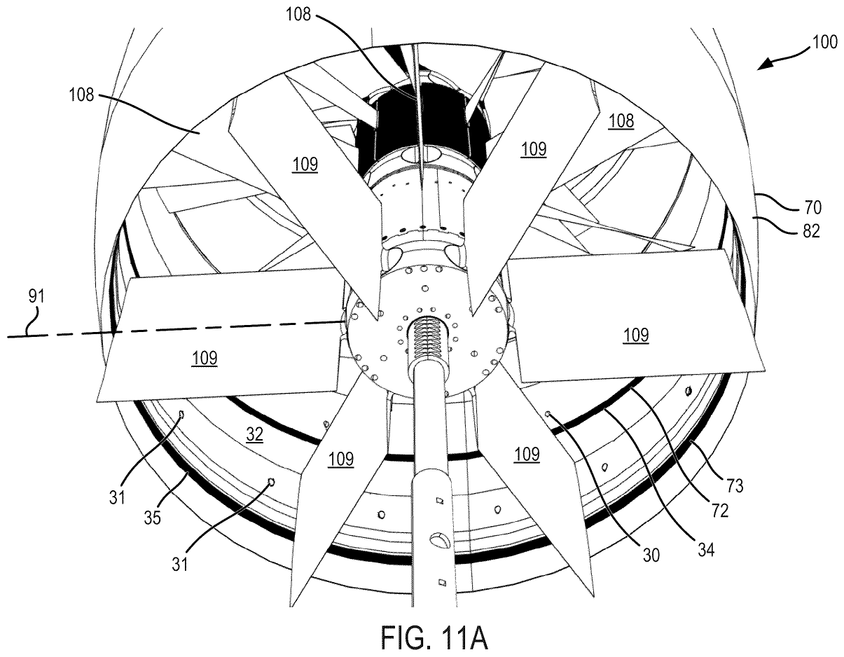

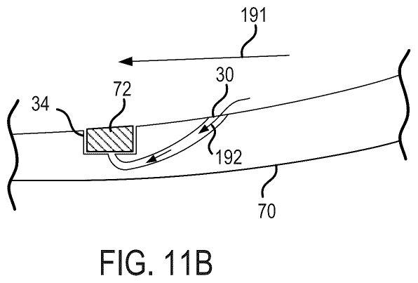

FIG. 11A illustrates a perspective view from below the propulsion system 100. Floating air bearing 72 may be located radially outward from the turbine blades 108. Floating air bearing 72 may comprise an annular ring. Floating air bearing may be made from a composite material (e.g., a fiber-reinforced composite material) or a metal or metal alloy material, among other materials. Floating air bearing 72 can be captured within the lower (aft) part of the duct 70, at the center of the power turbine blades, to provide additional stability to duct 70. An annular groove 34 may be disposed in the duct 70. More particularly, the annular groove 34 may be disposed in the inner diameter surface 32 of second half 82. A plurality of inlets 30 may be disposed circumferentially about the inner diameter surface 32 of the duct 70. Plurality of inlets 30 may be disposed upstream from annular groove 34. The plurality of inlets 30 are in fluid communication with the annular groove 34. In this manner, air from within duct 70 may be diverted into inlets 30 and provide air pressure to floating air bearing 72 to center the air bearing 72 within the annular groove 34. In various embodiments, the tips of turbine blades 108 contact floating air bearing 72. Due to the floating air bearing 72 being floatingly coupled to the duct 70, the floating air bearing 72 may rotate about the longitudinal axis of the propulsion system 100 with respect to duct 70. Stated differently, floating air bearing 72 is not rigidly attached to duct 70, in accordance with various embodiments.

In various embodiments, floating air bearing 72 is located at the center of the turbine blades 108. Stated differently, a longitudinal axis extending along the length of each turbine blade 108 can intersect floating air bearing 72. In this manner, turbine blades 108 may rotate with respect to floating air bearing 72 about their longitudinal axis even when the turbine blades 108 are in contact with floating air bearing 72, with minimal friction therebetween. In various embodiments, the tips of turbine blades 108 may be tapered to minimize friction between floating air bearing 72 and turbine blades 108. In various embodiments, floating air bearing 72 increases the rigidity of duct 70 and may reduce radial flexing of duct 70. In this manner, blade tip clearances of the propulsion system 100 may be decreased.

In various embodiments, a second floating air bearing 73 is similarly situated radially outward from turbine blades 109. Floating air bearing 73 can similarly be located at the center of the turbine blades 109 (i.e., at the longitudinal axis 91 of turbine blades 109). Floating air bearing 73 can be located downstream from floating air bearing 72. In this regard, a second annular groove 35 can be disposed in the inner diameter surface 32 of the duct 70. Moreover, a second plurality of inlets 31 can be disposed in the inner diameter surface 32 upstream from second annular groove 35 and in fluid communication with the annular groove 35.

With reference to FIG. 11B, a section view of the floating air bearing 72 installed in the duct 70 is schematically illustrated, in accordance with various embodiments. A portion 192 of the core air flow 191 from the propulsion system may be diverted through inlets 30 and into the annular groove 34 whereby the air pressure from the diverted core air 192 acts on floating air bearing 72 cause the floating air bearing 72 to remain centered within the annular groove 34 whereby the floating air bearing 72 is spaced apart from the duct 70.

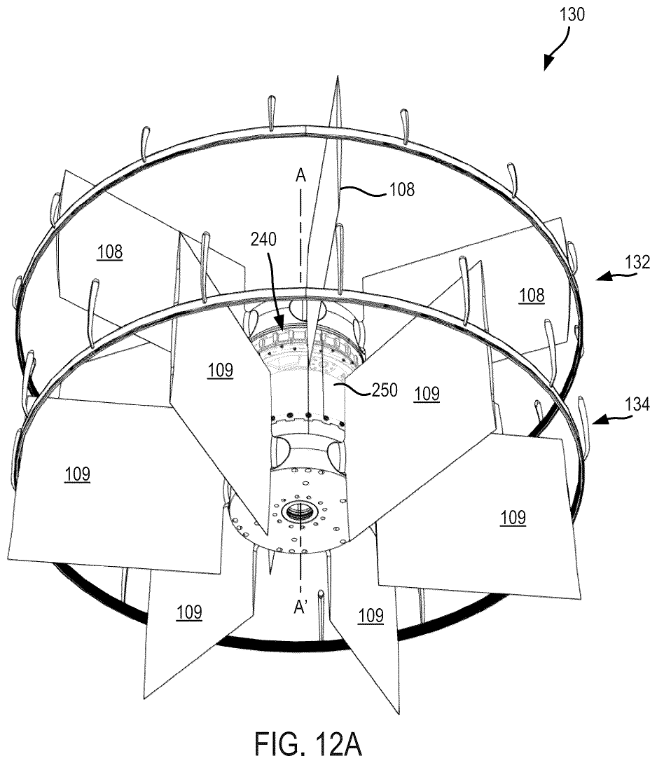

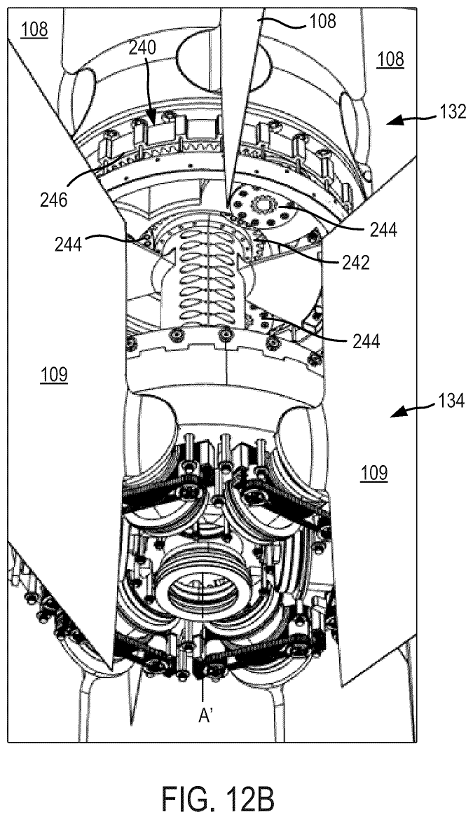

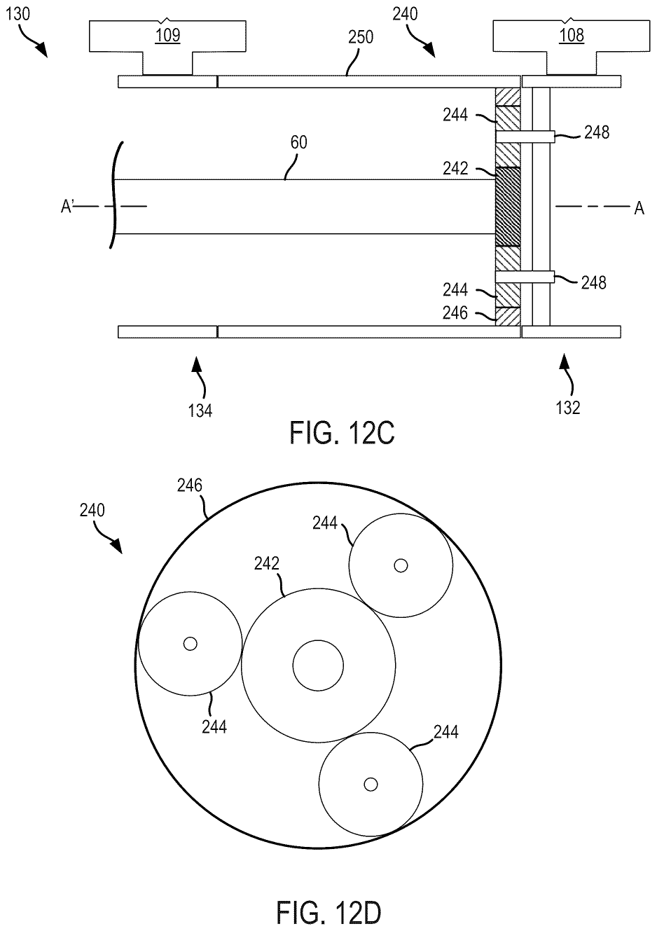

FIG. 12A is a perspective view of dual power turbine 130, in accordance with various embodiments. In various embodiments, the dual power turbine 130 can be configured as an eVTOL using only the electric jet propulsion system for lift, where the turbine blades are used for directional control and to induce rotation of the skyboom. The dual power turbine 130 design can be configured for heavy lift with eVTOL aircraft in rotorcraft (rotorwing aircraft) mode, in accordance with various embodiments. In various embodiments, first power turbine module 132 is operatively coupled to second power turbine module 134 via a planetary gear drive 240. With reference to FIG. 12B, an enlarged view of the planetary gear drive 240 installed in the dual power turbine 130 is illustrated with a ring gear sleeve 250 removed for ease of illustration, in accordance with various embodiments. With additional reference to FIG. 12C and FIG. 12D, which schematically illustrate the planetary gear drive 240 in accordance with various embodiments, the planetary gear drive 240 comprises a sun gear 242 coupled to stanchion 60. In various embodiments, sun gear 242 rotates together with stanchion 60. A plurality of planet gears 244 surround and meshingly engage the sun gear 242. The plurality of planet gears 244 are disposed circumferentially about the sun gear 242. A ring gear 246 surrounds and meshingly engages the plurality of planet gears 244. Each planet gear 244 can be mounted to first power turbine module 132 via a gear shaft 248. Ring gear 246 is coupled to a ring-gear sleeve 250. Ring gear 246 can rotate about axis A-A′ with ring-gear sleeve 250. Ring gear sleeve 250 can extend between and to first power turbine module 132 and second power turbine module 134. Diverting thrust
using first plurality of turbine blades 108 and second plurality of turbine blades 109—can create an opposing torque load between the first power turbine module 132 and second power turbine module 134, thereby causing the eVTOL aircraft to rotate. In various embodiments, planetary gear drive 240 may be devoid of a lubrication due to its low rotations per minute and the trochoidal drive system.

In various embodiments, aerodynamic forces from core air through propulsion system 100 can act on turbine blades 109 to cause the turbine blades 109 and ring gear sleeve 250 to rotate about axis A-A′. The ring gear 246 can be fixed to ring gear sleeve 250 such that the ring gear 246 rotate about axis A-A′ together with the ring gear sleeve 250 and blades 109. As the ring gear 246 rotates about axis A-A′, the meshing engagement of ring gear 246 with planet gears 244 causes the planet gears 244 to rotate about their respective gear shafts 248, which in turn applies a rotational torque to stanchion 60. In this manner, skyboom 52 (see FIG. 1A) can be caused to rotate—e.g., in rotorcraft mode—using dual power turbine 130.

In various embodiments, aerodynamic forces from core air through propulsion system 100 can act on turbine blades 108 to cause the turbine blades 108 and planet gears 244 to rotate about axis A-A′. The planet gears 244 can be pivotally coupled to turbine blades 108—e.g., via gear shafts 248—such that the planet gears 244 rotate about axis A-A′ together with turbine blades 108. As the planet gears 244 rotate about axis A-A′, the meshing engagement of planet gears 244 with sun gear 242 and the ring gear 246 causes the sun gear 242 and the stanchion 60 to rotate about axis A-A′. In this manner, skyboom 52 (see FIG. 1A) can be caused to rotate—e.g., in rotorcraft mode—using dual power turbine 130. In various embodiments, both turbine blades 108 and turbine blades 109 rotate about axis A-A′ to apply a combined torque to stanchion 60.

In various embodiments, the pitch of each of the first plurality of turbine blades 108 can be varied as desired. In various embodiments, the pitch of each of the second plurality of turbine blades 109 can be varied as desired. In various embodiments, the pitch of each of the first plurality of turbine blades 108 is controlled independently from that of the second plurality of turbine blades 109 as desired.

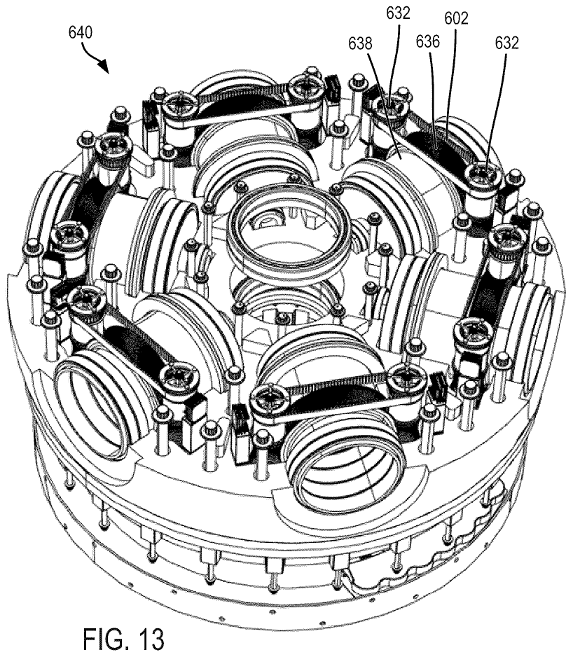

FIG. 13 is a perspective view of a blade actuation control system 640 for a power turbine module (e.g., first power turbine module 522 and/or second power turbine module 524), in accordance with various embodiments. In various embodiments, blade actuation control system 640 is similar to the components described with respect to FIG. 9B herein, except that each sleeve 638 may comprise a driven gear 636 disposed between the ends of the sleeve 638. Stated differently, driven gear 636 may be spaced apart from an end of the sleeve 638. In various embodiments, the driven gear 636 is located at an axially central portion (e.g., between 25% and 75% of the length of the sleeve 638 measured from an end of the sleeve 638) of the sleeve 638. In various embodiments, driven gear 636 is formed integrally with sleeve 638 (e.g., driven gear 636 and sleeve 638 may be formed as a single piece).

In various embodiments, each sleeve comprises a pair of dedicated globoid motors 632 meshingly engaged at opposite sides of the driven gear 636. Globoid motors 632 can be configured to rotate the sleeve to vary a pitch angle of the turbine blades 508. A timing belt 602 can be meshingly engaged with each pair of dedicated globoid motors 632 to provide redundant control of the globoid motors 632 and to ensure synchronous operation of the globoid motors 632.

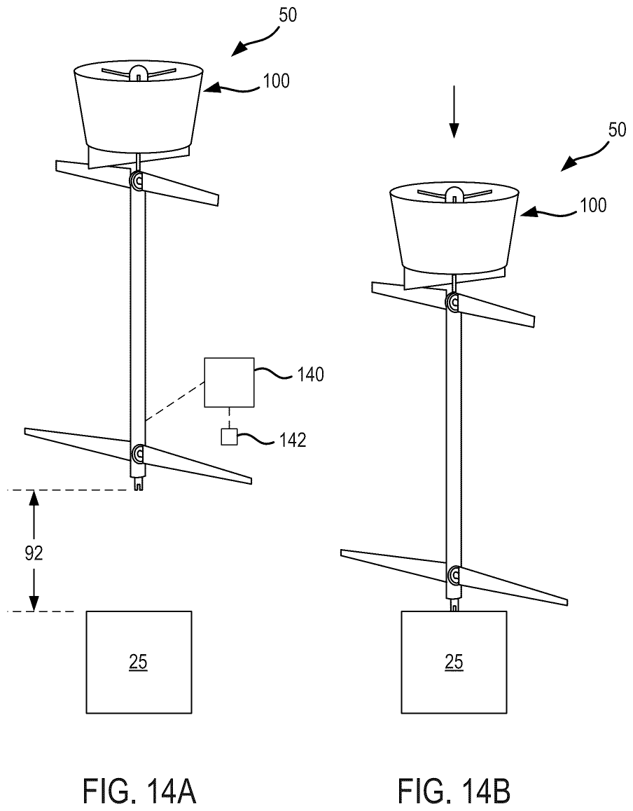

FIG. 14A and FIG. 14B illustrate eVTOL aircraft 50 during a payload loading maneuver. In FIG. 14A, the eVTOL aircraft 50 is located a distance 92 above a payload 25. Payload 25 may be a container filled with one or more of equipment, munitions, water, etc. Payload 25 may be a vehicle with or without one or more passengers. Payload 25 may be any suitable payload which is desirable to transport by air.

In various embodiments, eVTOL aircraft 50 further includes an avionics unit 140 (illustrated schematically in FIG. 14A), which includes one or more controllers (e.g., processors) and one or more tangible, non-transitory memories capable of implementing digital or programmatic logic. In various embodiments, for example, the one or more controllers are one or more of a general purpose processor, digital signal processor (DSP), application specific integrated circuit (ASIC), field programmable gate array (FPGA), or other programmable logic device, discrete gate, transistor logic, or discrete hardware components, or any various combinations thereof or the like. In various embodiments, the avionics unit 140 controls, at least various parts of, the flight of, and operation of various components of, the eVTOL aircraft 50. For example, the avionics unit 140 controls various parameters of flight, such as an air traffic management systems, auto-pilot systems, auto-thrust systems, alerting systems, electrical systems, electronic checklist systems, electronic flight bag systems, propulsion systems, guidance systems, navigation systems, flight control systems, environmental systems, hydraulics systems, lighting systems, pneumatics systems, traffic avoidance systems, trim systems, and the like.

In various embodiments, eVTOL aircraft 50 further includes various sensors 142 (illustrated schematically in FIG. 14A) for guidance, navigation, and/or control of eVTOL aircraft 50. Sensors 142 may include LiDAR, radar, sonar, GPS/GNSS (satellite interface) sensors, and/or cameras for location awareness and/or detecting obstacles and objects, such as payload 25 for example.

For example, during a payload loading maneuver, eVTOL aircraft 50 may detect distance 92 between eVTOL aircraft 50 and the payload 25 using sensors 142. In this regard, eVTOL aircraft 50 may determine that the eVTOL aircraft 50 should be lowered by distance 92 in order to attach the payload 25 to the eVTOL aircraft 50. One method of controlling a height of eVTOL aircraft 50 is to shutter the rotor blades 122 and/or rotor blades 126 to precisely control a height of eVTOL aircraft 50. As used herein, “shutter” can refer to rapid, successive adjustments to the pitch of the rotor blades 122 and/or rotor blades 126 in order to vary the thrust generated by propulsion system 100.

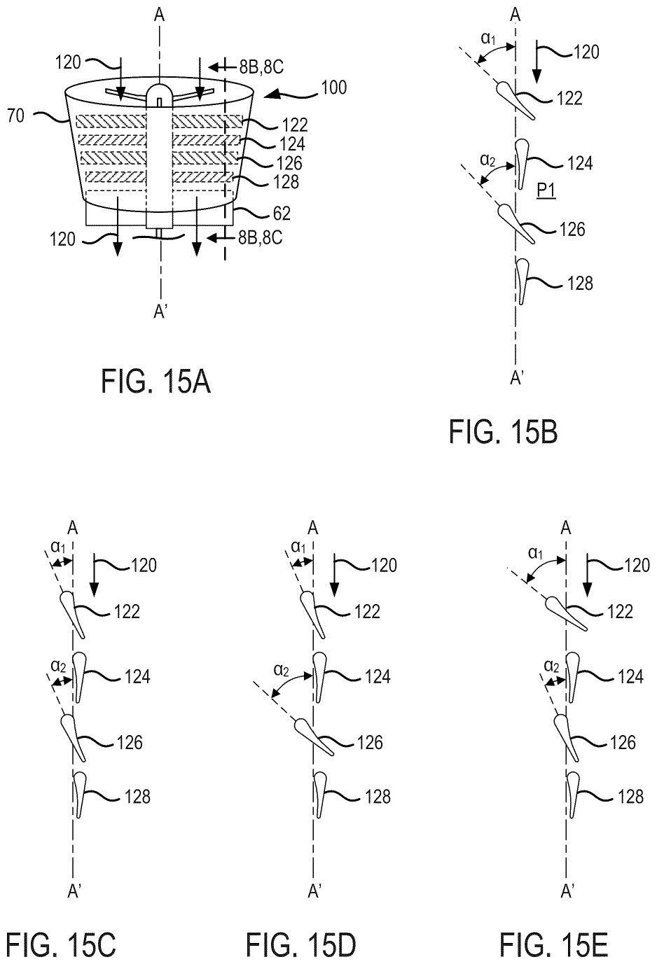

With additional reference to FIG. 15A through FIG. 15E, the pitch or angle α₁ of rotor blades 122 and the pitch or angle α₂ of rotor blades 126 may be shuttered (i.e., varied) to fine tune the thrust generated by propulsion system 100 and thereby provide fine and accurate height adjustments to eVTOL aircraft 50. The pitch of the rotor blades 122 and/or rotor blades 126 may be varied using the motor 232 associated with the rotor blade 122, 126 being actuated, with momentary reference to FIG. 6. For example, rotor blades 122 may initially be at angle α₁ and rotor blades 126 may initially be at angle α₂ when eVTOL aircraft 50 is at distance 92. eVTOL aircraft 50 may determine—e.g., using avionics unit 140—a desirable height adjustment, for example to close the distance 92 between eVTOL aircraft 50 and payload 25. In order to make accurate height adjustments, avionics unit 140 may command the pitch of rotor blades 122 and/or rotor blades 126 to vary in order to adjust an altitude of eVTOL aircraft 50. In various embodiments, with particular focus on FIG. 15C, both angle α₁ and angle α₂ may be varied (e.g., increased or decreased as desired depending on the desired altitude adjustment). In various embodiments, with particular focus on FIG. 15D, angle α₁ may be varied (e.g., increased or decreased as desired depending on the desired altitude adjustment) and angle α₂ may remain constant. In various embodiments, with particular focus on FIG. 15E, angle α₂ may be varied (e.g., increased or decreased as desired depending on the desired altitude adjustment) and angle α₁ may remain constant. For example, angle α₁ may be varied to increase a pressure P1 between rotor blades 122 and rotor blades 126. Rotor blades 126 may then accelerate the pressurized air to generate an increase in thrust to increase an altitude of eVTOL aircraft 50. Conversely, angle α₁ may be varied to decrease a pressure P1 between rotor blades 122 and rotor blades 126. Rotor blades 126 may then accelerate the pressurized air to generate a decrease in thrust to decrease an altitude of eVTOL aircraft 50. It should be understood that the pitch of rotor blades 122 and/or rotor blades 126 may be independently adjusted to precisely control an altitude of eVTOL aircraft 50 in various ways and various adjustments may be made during a single maneuver. In this regard, various combinations of pitch adjustment of rotor blades 122 and/or rotor blades 126 are contemplated herein for precisely and quickly controlling the altitude of eVTOL aircraft 50. The pitch of the rotor blades 122 and/or rotor blades 126 can be varied based on the feedback signals from the sensors 142 (see FIG. 14A) with altitude data and/or distance data (e.g., distance 92). In various embodiments, the pitch of the rotor blades 122 and/or rotor blades 126 is varied while maintaining a constant speed command to the rotor blades 122 and/or rotor blades 126. For example, the speed command send to electric motors 204 and/or 205 (see FIG. 3A and FIG. 3B) may remain constant while the pitch of the rotor blades 122 and/or rotor blades 126 is varied.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure and may be expressed in the following claims.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element of any or all the claims.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, a thermal connection, and/or any other connection. When language similar to “at least one of A, B, or C” or “at least one of A, B, and C” is used in the specification or claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. An aircraft comprising:
a boom;
a propulsion system coupled to a first end of the boom via a stanchion; and
a first wing coupled to a second end of the boom;
wherein the propulsion system comprises:
a first plurality of rotor blades configured to rotate about an engine longitudinal axis; and
a motor module comprising a first plurality of electric motors for rotating the first plurality of rotor blades.

2. The aircraft of claim 1, wherein the propulsion system further comprises:
a second plurality of rotor blades disposed opposite the motor module from the first plurality of rotor blades; and
a first plurality of stator vanes extending from the motor module, the first plurality of stator vanes located axially between the first plurality of rotor blades and the second plurality of rotor blades.

3. The aircraft of claim 2, wherein the propulsion system further comprises:
a second plurality of stator vanes; and
a duct coupled to the first plurality of stator vanes and defining a core flow path, the duct comprises a first half slidingly coupled to a second half, the first half is coupled to the first plurality of stator vanes and the second half is coupled to the second plurality of stator vanes, and the first half is configured to rotate about the propulsion system longitudinal axis with respect to the second half.

4. The aircraft of claim 2, wherein the propulsion system further comprises:
a duct coupled to the first plurality of stator vanes and defining a core flow path;
an annular groove disposed in the duct;
a floating air bearing disposed in the annular groove; and
a plurality of inlets disposed circumferentially about the duct and in fluid communication with the annular groove, wherein the plurality of inlets are configured to divert a portion of a core air flow and direct the portion of the core air flow to the annular groove.

5. The aircraft of claim 1, wherein the first plurality of electric motors comprises a first electric motor and a second electric motor; and
wherein the motor module further comprises:
a plurality of heat exchangers comprising a first heat exchanger and a second heat exchanger;
a first coolant reservoir;
a second coolant reservoir;
a first coolant flow path extending from the first coolant reservoir, through the first electric motor, through the second coolant reservoir, through the first heat exchanger, and back into the first coolant reservoir; and
the first heat exchanger comprises an aerodynamic surface configured to be in fluid communication with a core air flow during operation of the propulsion system.

6. The aircraft of claim 5, wherein the motor module further comprises a center frame at least partially defining a first motor cavity, a second motor cavity, and a third motor cavity; and
wherein the first electric motor is disposed in the first motor cavity, the second electric motor is disposed in the second motor cavity, and the first plurality of electric motors further comprises a third electric motor disposed in the third motor cavity.

7. The aircraft of claim 6, wherein the first coolant reservoir comprises a first coolant cavity fluidly sealed from a second coolant cavity and a third coolant cavity; and
the first coolant cavity is in fluid communication with the first electric motor via the first coolant flow path, the second coolant cavity is in fluid communication with the second electric motor via a second coolant flow path, and the third coolant cavity is in fluid communication with the third electric motor via a third coolant flow path.

8. The aircraft of claim 7, wherein the motor module further comprises a first motor control housing for the first electric motor, a second motor control housing for the second electric motor, and a third motor control housing for the third electric motor; and
the first coolant flow path is in fluid communication with the first motor control housing.

9. The aircraft of claim 1, wherein the motor module further comprises:
a center frame comprising a first flange;
a harmonic damper comprising a second flange; and
a damper ring disposed between the first flange and the second flange.

10. The aircraft of claim 9, wherein the harmonic damper further comprises a first post extending into an output shaft of a first electric motor of the first plurality of electric motors, wherein a bearing is disposed between the first post and the output shaft of the first electric motor, wherein the bearing is configured to transfer loads between the first post and the output shaft of the first electric motor.

11. The aircraft of claim 2, wherein:
the first plurality of electric motors comprises a first electric motor, a second electric motor, and a third electric motor;
the motor module further comprises a first output shaft meshingly engaged with the first electric motor, the second electric motor, and the third electric motor;
the first plurality of electric motors is configured to drive the first output shaft; and
the first plurality of rotor blades are mounted to the first output shaft.

12. The aircraft of claim 11, further comprising a second plurality of electric motors comprising a fourth electric motor, a fifth electric motor, and a sixth electric motor;
the motor module further comprises a second output shaft meshingly engaged with the fourth electric motor, the fifth electric motor, and the sixth electric motor;
the second plurality of electric motors are configured to drive the second output shaft; and
the second plurality of rotor blades are mounted to the second output shaft.

13. A propulsion system comprising:
a first plurality of rotor blades configured to rotate about an engine longitudinal axis; and
a motor module comprising:
a first plurality of electric motors for rotating the first plurality of rotor blades; and
a harmonic damper comprising a plurality of posts, wherein each post extends into an output shaft of the first plurality of electric motors.

14. The propulsion system of claim 13, further comprising:
a second plurality of rotor blades disposed opposite the motor module from the first plurality of rotor blades; and
a first plurality of stator vanes extending from the motor module, the first plurality of stator vanes is located axially between the first plurality of rotor blades and the second plurality of rotor blades.

15. The propulsion system of claim 13, wherein the motor module further comprises:
a center frame comprising a first flange; and
a damper ring disposed between the first flange and a second flange of the harmonic damper.

16. The propulsion system of claim 15, wherein the damper ring comprises an elastomeric material.

17. The propulsion system of claim 15, wherein the first plurality of electric motors is mounted to the center frame.

18. The propulsion system of claim 17, wherein the center frame comprises an end plate, and each output shaft of the first plurality of electric motors extends through the end plate.

19. A propulsion system comprising:
a first plurality of rotor blades configured to rotate about an engine longitudinal axis; and
a motor module comprising:
a first plurality of electric motors for rotating the first plurality of rotor blades;
a first coolant reservoir configured to contain a coolant for providing cooling to the first plurality of electric motors; and
a plurality of heat exchangers disposed circumferentially about the motor module and at least partially defining a core flow path through the propulsion system.

20. The propulsion system of claim 19, further comprising:
a second plurality of rotor blades disposed opposite the motor module from the first plurality of rotor blades;
a first plurality of stator vanes extending from the motor module;
a ram air inlet extending through a first heat exchanger of the plurality of heat exchangers into the core flow path; and
a ram air exhaust in fluid communication with the core air flow path;
the ram air inlet is configured to receive a cooling air from the core flow path and direct the cooling air through at least a first electric motor of the first plurality of electric motors, and the ram air exhaust is configured to direct the cooling air from at least the first electric motor back into the core flow path;
the motor module further comprises a second plurality of electric motors for rotating the second plurality of rotor blades; and
the first plurality of stator vanes is located axially between the first plurality of rotor blades and the second plurality of rotor blades.
